(19) United States
(12) Patent Application Publication
(10) Pub. No.: US 2019/0249275 A1
(43) Pub. Date: Aug. 15, 2019

(54) CONDUCTIVE MATERIAL FOR CONNECTION PARTS WHICH HAS EXCELLENT MINUTE SLIDE WEAR RESISTANCE

(71) Applicant: Kabushiki Kaisha Kobe Seiko Sho (Kobe Steel, Ltd.), Kobe-shi (JP)

(72) Inventor: Masahiro TSURU, Yamaguchi (JP)

(73) Assignee: Kabushiki Kaisha Kobe Seiko Sho (Kobe Steel, Ltd.), Kobe-shi (JP)

(21) Appl. No.: 16/397,472

(22) Filed: Apr. 29, 2019

Related U.S. Application Data
(62) Division of application No. 15/506,149, filed on Feb. 23, 2017.

(30) Foreign Application Priority Data
Aug. 25, 2014 (JP) 2014-170879
Aug. 25, 2014 (JP) 2014-170956
Aug. 27, 2014 (JP) 2014-172281

(51) Int. Cl. C22C 9/02; C23C 28/02; H01R 13/03; H01B 5/02; C22C 13/00; C22C 9/10; C22C 9/06; C25D 5/10; C22C 9/04; C22C 9/01; C22C 9/00; C25D 7/00; C25D 5/50; C25D 5/12; C22C 9/05

(52) U.S. Cl. CPC C22C 9/02; C22C 9/05; H01R 13/03; H01B 5/02; C22C 13/00; C22C 9/10; C22C 9/06; C25D 5/10; C22C 9/04; C22C 9/01; C22C 9/00; C25D 7/00; C25D 5/50; C25D 5/12; C23C 28/021

(57) ABSTRACT

A conductive material for connection parts includes a matrix, a Cu—Sn alloy covering layer having a Cu content of 20 to 70 at % and an average thickness of from 0.2 to 3.0 μm, and a Sn covering layer having an average thickness of from 0.05 to 5.0 μm. The matrix is a copper alloy strip containing specified amounts of Fe and P. The Cu—Sn alloy covering layer and the Sn covering layer are formed in this order on a surface of the matrix.

### TECHNICAL FIELD

The present invention relates to a conductive material for connecting parts, such as terminal, used mainly in the automotive field and the general consumer field. More specifically, it relates to a Sn-plated conductive material for connecting parts, which uses a copper alloy as the matrix and can reduce fretting wear.

### BACKGROUND ART

As the material of a mating terminal for a multi-pole connector used in a device for electronically controlling an automotive engine (ECU: Electronic Control Unit), etc., various copper alloys such as Cu—Ni—Si, Cu—Ni—Sn—P, Cu—Fe—P, and Cu—Zn are used. The mating terminal is composed of a male terminal and a female terminal and in general, different copper alloys are usually used for the male terminal and the female terminal in consideration of the intended purpose, usage environment, cost, etc. of the mating terminal.

Of those, the Cu—Ni—Si alloy is characterized by having a tensile strength of 600 MPa or more, a moderate electrical conductivity (from 25 to 50% IACS), and a stress relaxation rate of approximately from 15 to 20% after holding at 150° C. for 1,000 hours in the state of being loaded with a bending stress of 80% of 0.2% yield strength, and is excellent in the strength and resistance to stress relaxation.

As the Cu—Fe—P alloy, for example, C19210 and C194 are known, and these Cu—Fe—P alloys are characterized by having a tensile strength of approximately from 400 to 600 MPa, an electrical conductivity of 60 to 90% IACS, and a stress relaxation rate of 60% or less under the conditions above. In the mating terminal, the one requiring resistance to stress relaxation is a female terminal, and a copper alloy having a stress relaxation rate of 25% or less under the conditions above is usually selected. In addition, the Cu—Fe—P alloy is higher in the electrical conductivity than the Cu—Ni—Si alloy or brass and is advantageous in suppressing a temperature rise when the terminal is miniaturized (the contact area between male-female terminals becomes small). The stress relaxation rate thereof is smaller by 15% or more than brass. Furthermore, in the stamped surface of a terminal manufactured by stamping a copper alloy strip pre-plated with Sn, the matrix is exposed, but in the case of a Cu—Fe—P alloy where the total content of alloy elements including Fe is 2.5 mass % or less, the exposed region exhibits excellent solder wettability and can be soldered without post-plating Sn. Because of these advantages, the Cu—Fe—P alloy is used particularly for small mating terminals, and among them, further for a male terminal not so much requiring resistance to stress relaxation.

The Cu—Zn alloy includes Cu—Zn alloys containing from 10 to 40% (mass %, hereinafter the same) of Zn specified in JIS H 3100 as C2200 (10% Zn), C2300 (15% Zn), C2400 (20% Zn), C2600 (30% Zn), C2700 (35% Zn), and C2801 (40% Zn). These Cu—Zn alloys are called red brass or brass. Such Cu—Zn alloys have a moderate electrical conductivity (from 25 to 45% IACS), a good balance between strength and ductility (bending workability), and a high spring limit value. It has a stress relaxation rate of more than 50% under the conditions above. In addition, since it contains much Zn which is less expensive than Cu and the thermo-mechanical treatment step is relatively simple, the cost is low. Because of these advantages, the Cu—Zn alloy is used for small mating terminals, and among them, further for a male terminal not so much requiring resistance to stress relaxation.

In the mating terminal, an Sn covering layer (e.g., reflow Sn plating) of about 1 μm in thickness is provided on the surface so as to, for example, ensure the corrosion resistance and reduce the contact resistance in the contact part. In the mating terminal having formed thereon an Sn covering layer, during insertion of a male terminal into a female terminal, the soft Sn covering layer (Vickers hardness Hv: approximately from 10 to 30) is plastically deformed to shear the Sn—Sn adhesion part produced between male-female terminals. Due to deformation resistance and shearing resistance generated here, in the mating terminal having formed thereon an Sn covering layer, the insertion force of a terminal increases. Since ECU above is connected by a connector accommodating a large number of mating terminals, the insertion force at the connection increases with an increase in the number of channels. Accordingly, from the viewpoint of, for example, reducing the strain on a worker and securing the completeness of connection, it is demanded to decrease the insertion force of a mating terminal.

After the mating of terminals, a fretting wear phenomenon becomes a problem. The fretting wear phenomenon is a phenomenon where sliding is generated between a male terminal and a female terminal due to vibration from an automotive engine, vibration during running, expansion or contraction arising from variation in the ambient temperature, etc. and the Sn plating on the terminal surface is thereby abraded. The abraded powder of Sn produced by the fretting wear phenomenon is oxidized and when a large amount thereof is accumulated in the vicinity of the contact point and caught between contact points which slide relative to each other, mutual contact resistance of the contact points increases. The fretting wear phenomenon is more likely to occur as the contact pressure between a male terminal and a female terminal is smaller, and therefore, it especially readily occurs in a mating terminal where the insertion force is small (the contact pressure is low).

In the case of a terminal incorporated into a device such as ECU used in a high-temperature environment as in an engine room of an automobile, with an aim to ensure reliability as the terminal, the initial contact pressure of the terminal is determined so that a contact pressure not less than a given value can be maintained after holding for a long time at a temperature of about 150° C.

With respect to the mating terminal having thereon such a Sn covering layer, Patent Document 1 describes a conductive material for connecting parts, in which surface plating layers including a Ni layer with a thickness of 0.1 to 1.0 μm, a Cu—Sn alloy layer with a thickness of 0.1 to 1.0 μm, and a Sn layer with a thickness of 2 μm or less are formed in this order on a copper alloy matrix surface. According to the description of Patent Document 1, when the thickness of the Sn layer is 0.5 μm or less, the dynamic friction coefficient decreases, and the insertion force can be kept low when used as a multi-pole mating terminal.

Patent Document 2 describes a conductive material for connecting parts, obtained by subjecting a surface of a copper alloy matrix with increased surface roughness to, if desired, Ni plating, then to Cu plating and Sn plating in this order, and then to reflow processing. This conductive material for connecting parts has surface covering layers including a Ni covering layer (when Ni plating is performed) with a thickness of 3 μm or less, a Cu—Sn alloy covering layer with a thickness of 0.2 to 3 μm, and a Sn covering layer with a thickness of 0.2 to 5 μm on a copper alloy matrix surface. In this conductive material for connecting parts, since the hard Cu—Sn alloy covering layer is partially exposed through the Sn covering layer, the dynamic friction coefficient is small and when used as a mating terminal, the insertion force can be decreased without reducing the contact pressure of the terminal. In Patent Document 2, Examples of the Invention, where the copper alloy matrix is a Cu—Zn alloy or a Cu—Fe—P alloy, are described.

Patent Document 3 describes a conductive material for connecting parts, having the same covering layer constituents as in Patent Document 2, and Examples of the Invention, where in the conductive material for connecting parts, the copper alloy matrix is a Cu—Ni—Si alloy.

### PRIOR ART LITERATURE

### Patent Document

Patent Document 1: JP-A-2004-68026

Patent Document 2: JP-A-2006-183068

Patent Document 3: JP-A-2007-258156

### SUMMARY OF THE INVENTION

### Problems that the Invention is to Solve

In the conductive material for connecting parts described in Patent Document 1, the dynamic friction coefficient in insertion of the terminal can be greatly decreased, compared with a conventional reflow Sn-plated material. In the conductive materials for connecting parts described in Patent Documents 2 and 3, the dynamic friction coefficient in insertion of the terminal is more decreased than in the conductive material for connecting parts described in Patent Document 1, and it is not necessary to reduce the contact pressure of the terminal so as to decrease the insertion force. Accordingly, fretting wear is less likely to occur compared with a conventional Sn-plated copper alloy material, and an abraded powder of Sn is produced in a small amount, as a result, the increase in contact resistance is suppressed. For this reason, the conductive material above for connecting parts is increasingly used in practice in the fields of automobile, etc.

However, with the recent miniaturization of terminal, the contact area in the mating part becomes small, causing a problem of terminal temperature rise. Accordingly, a mating terminal that can be used even at a temperature exceeding 160° C., for example, at 180° C., is required. In order to suppress the temperature rise in the terminal mating part, it is demanded to improve the fretting wear resistance and as to the matrix copper alloy, provide a copper alloy having a higher electrical conductivity than Cu—Ni—Si alloy. Under these circumstances, with respect to a female terminal constituting the mating terminal, a copper alloy material for terminals, having a stress relaxation rate of about 20% after holding at 180° C. for 1,000 hours, is required. Here, the stress relaxation rate of a general Cu—Ni—Si alloy after holding of 180° C.×1,000 hours exceeds 25%, and the electrical conductivity is about 50% at a maximum. With respect to a male terminal as well, in order not to raise the contact resistance even when slid at a high temperature of 160° C. or more, further improvement of the fretting wear resistance is required.

An object of the present invention is to provide a conductive material for connecting parts, which is suited for miniaturization of a mating-type terminal, undergoes less reduction in the contact pressure even after use for a long time at a temperature exceeding 160° C., and exhibits more excellent fretting wear resistance compared with the conductive materials for connecting parts described in Patent Document 1 and furthermore in Patent Documents 2 and 3.

### Means for Solving the Problems

A first conductive material for connecting parts according to the present invention is a conductive material for connecting parts, including a copper alloy strip as a matrix, the copper alloy strip containing one member or two members of Cr: from 0.15 to 0.70 mass % and Zr: from 0.01 to 0.20 mass %, with a remainder being Cu and an unavoidable impurity, and the conductive material including a Cu—Sn alloy covering layer having a Cu content of 20 to 70 at % and a Sn covering layer, which have been formed in this order on a surface of the matrix, in which a surface of the material has been subjected to a reflow processing and has an arithmetic mean roughness Ra in at least one direction of 0.15 μm or more and an arithmetic mean roughness Ra in all directions of 3.0 μm or less, the Sn covering layer has an average thickness of from 0.05 to 5.0 μm, the Cu—Sn alloy covering layer has been formed to be partially exposed at a surface of the Sn covering layer, the Cu—Sn alloy covering layer has an exposed area ratio of from 3 to 75% on the surface of the conductive material, and the Cu—Sn alloy covering layer has an average thickness of from 0.2 to 3.0 μm and an average grain size in a surface thereof of less than 2 μm, and in which the copper alloy strip has an electrical conductivity of more than 50% IACS and a stress relaxation rate after holding at 200° C. for 1,000 hours of 25% or less.

In the first conductive material for connecting parts, the copper alloy strip may further contain at least one of the following (A) and (B):

(A) one member or two members selected from Ti: from 0.01 to 0.30 mass % and Si: from 0.01 to 0.20 mass %; and

(B) 1.0 mass % or less in total of one or more members of Zn: from 0.001 to 1.0 mass %, Sn: from 0.001 to 0.5 mass %, Mg: from 0.001 to 0.15 mass %, Ag: from 0.005 to 0.50 mass %, Fe: from 0.005 to 0.50 mass %, Ni: from 0.005 to 0.50 mass %, Co: from 0.005 to 0.50 mass %, Al: from 0.005 to 0.10 mass %, and Mn: from 0.005 to 0.10 mass %.

A second conductive material for connecting parts according to the present invention is a conductive material for connecting parts, including a copper alloy strip as a matrix, the copper alloy strip containing Fe: from 0.01 to 2.6 mass % and P: from 0.01 to 0.3 mass %, with a remainder being Cu and an unavoidable impurity, and the conductive material including a Cu—Sn alloy covering layer having a Cu content of 20 to 70 at % and a Sn covering layer, which have been formed in this order on a surface of the matrix, in which a surface of the material has been subjected to a reflow processing and has an arithmetic mean roughness Ra in at least one direction of 0.15 μm or more and an arithmetic mean roughness Ra in all directions of 3.0 μm or less, the Sn covering layer has an average thickness of from 0.05 to 5.0 μm, the Cu—Sn alloy covering layer has been formed to be partially exposed at a surface of the Sn covering layer, the Cu—Sn alloy covering layer has an exposed area ratio of from 3 to 75% on the surface of the conductive material, and the Cu—Sn alloy covering layer has an average thickness of from 0.2 to 3.0 μm and an average grain size in a surface thereof of less than 2 μm, and in which the copper alloy strip has an electrical conductivity of more than 55% IACS and a stress relaxation rate after holding at 150° C. for 1,000 hours of 60% or less.

In the second conductive material for connecting parts, the copper alloy strip may further contain at least one of the following (C) and (D):

(C) one member or two members of Sn: from 0.001 to 0.5% and Zn: from 0.005 to 3.0%; and

(D) from 0.001 to 0.5 mass % in total of one member or two or more members selected from Mn, Mg, Ca, Zr, Ag, Cr, Cd, Be, Ti, Si, Co, Ni, Al, Au, and Pt.

A third conductive material for connecting parts according to the present invention is a conductive material for connecting parts, including a Cu—Zn alloy strip as a matrix, the Cu—Zn alloy strip containing from 10 to 40 mass % of Zn, with a remainder being Cu and an unavoidable impurity, and the conductive material including a Cu—Sn alloy covering layer having a Cu content of 20 to 70 at % and a Sn covering layer, which have been formed in this order on a surface of the matrix, in which a surface of the material has been subjected to a reflow processing and has an arithmetic mean roughness Ra in at least one direction of 0.15 μm or more and an arithmetic mean roughness Ra in all directions of 3.0 μm or less, the Sn covering layer has an average thickness of from 0.05 to 5.0 μm, the Cu—Sn alloy covering layer has been formed to be partially exposed at a surface of the Sn covering layer, the Cu—Sn alloy covering layer has an exposed area ratio of from 3 to 75% on the surface of the conductive material, and the Cu—Sn alloy covering layer has an average thickness of from 0.2 to 3.0 μm and an average grain size in a surface thereof of less than 2 μm, and in which the copper alloy strip has an electrical conductivity of 24% IACS or more and a stress relaxation rate after holding at 150° C. for 1,000 hours of 75% or less.

In the third conductive material for connecting parts, the Cu—Zn alloy strip may further contain from 0.005 to 1 mass % in total of one element or two or more elements selected from Cr, Ti, Zr, Mg, Sn, Ni, Fe, Co, Mn, Al, and P.

The first, second or third conductive material for connecting parts may further include an undercoat layer including one layer or two layers selected from a Ni covering layer, a Co covering layer and a Fe covering layer, the undercoat layer having been formed between the surface of the matrix and the Cu—Sn alloy covering layer, in which the undercoat layer may have an average thickness, singularly in the case of one layer or in total of both layers in the case of two layers, of from 0.1 to 3.0 μm, and may further include a Cu covering layer between the undercoat layer and the Cu—Sn alloy covering layer.

The first, second or third conductive material for connecting parts may further include a Sn plating layer having an average thickness of 0.02 to 0.2 μm formed on the material surface which has been subjected to the reflow processing.

### Advantage of the Invention

The first conductive material for connecting parts according to the present invention uses a copper alloy matrix having an electrical conductivity of more than 50% IACS and a stress relaxation rate of 25% or less after holding at 200° C. for 1,000 hours, and is thereby suited for miniaturization of a mating-type terminal and undergoes less reduction in the contact pressure after holding for a long time at a high temperature exceeding 160° C. In addition, less reduction in the contact pressure leads to enhancement of the fretting wear resistance compared, for example, with a Cu—Ni—Si alloy matrix. Furthermore, since the average grain size in the surface of the Cu—Sn alloy covering layer is less than 2 μm, the conductive material exhibits excellent fretting wear resistance, compared with a conventional conductive material for connecting parts. In the case of forming a Sn plating layer on the material surface which has been subjected to reflow processing, the solderability can be improved, compared with a conventional conductive material for connecting parts.

In the second conductive material for connecting parts according to the present invention, which is a conductive material for connecting parts, using a Cu—Fe—P alloy having a relatively large stress relaxation rate as the copper alloy matrix, the fretting wear resistance can be improved, compared with the conventional conductive material for connecting parts. Furthermore, in the case of forming a Sn plating layer on the material surface which has been subjected to reflow processing, the solderability can be improved, compared with the conventional conductive material for connecting parts.

In the third conductive material for connecting parts according to the present invention, which is a conductive material for connecting parts, using red brass or brass having a large stress relaxation rate as the copper alloy matrix, the fretting wear resistance can be improved, compared with a conventional conductive material for connecting parts. Furthermore, in the case of forming a Sn plating layer on the material surface which has been subjected to reflow processing, the solderability can be improved.

### BRIEF DESCRIPTION OF THE DRAWINGS

FIG. 1 is an SEM (scanning electron microscope) microstructure photograph of the Cu—Sn alloy covering layer surface of Example No. 6A in the Test A.

FIG. 2 is a conceptual view of a jig for measuring fretting wear.

FIG. 3 is a conceptual view of a jig for measuring friction coefficient.

FIG. 4 is an SEM (scanning electron microscope) microstructure photograph of the Cu—Sn alloy covering layer surface of Example No. 4B in the Test B.

FIG. 5 is an SEM (scanning electron microscope) microstructure photograph of the Cu—Sn alloy covering layer surface of Example No. 10C in the Test C.

### MODE FOR CARRYING OUT THE INVENTION

### Embodiment A

An embodiment corresponding to claim 1 of the present invention is described below.

### [Copper Alloy Matrix]

### (1) Properties of Copper Alloy

In a Cu—Ni—Si alloy widely used for the mating-type terminal, the stress relaxation rate when hold for 1,000 hours in the state of being loaded with a bending stress of 80% of 0.2% yield strength is from 12 to 20% when the holding temperature is 150° C. However, the stress relaxation rate increases with a rise of the holding temperature and becomes from 15 to 25% at 160° C., from 25 to 30% at 180° C., and from 30 to 40% at 200° C. In the case of a female terminal imposing a strict requirement on the stress relaxation rate, as described above, the stress relaxation rate after holding for 1,000 hours at an assumed operating temperature is often required on the design basis to be 25% or less. Accordingly, in the case where, for example, the assumed operating temperature exceeds 160° C., it is difficult to use a Cu—Ni—Si alloy as the material of a female terminal.

In addition, the Cu—Ni—Si alloy has an electrical conductivity of 50% IACS or less and is not suited for more miniaturization of a mating-type terminal.

In this embodiment, the copper alloy strip used as the matrix of the conductive material for connecting parts has a stress relaxation rate of 25% or less after holding at 200° C. for 1,000 hours, so that operation for a long time becomes possible even in a high-temperature environment at an ambient temperature of more than 160° C. Here, the value of the stress relaxation rate is presumed virtually unchanged between before and after reflow processing. The copper alloy strip according to this embodiment has an electrical conductivity of more than 50% IACS and is suited for more miniaturization of a mating-type terminal. The electrical conductivity of the copper alloy strip according to this embodiment is preferably 60% IACS or more, more preferably 70% IACS or more.

As such a copper alloy strip, Cu—Cr, Cu—Zr, Cu—Cr—Zr and Cu—Cr—Ti alloys which will be described later are suitable. Since these alloys exhibit excellent resistance to stress relaxation even at a temperature exceeding 160° C., the initial contact pressure can be set to a small value and in turn, the insertion force in insertion of the terminal can be reduced. On the other hand, when despite setting the contact pressure to a small value, the contact pressure is less reduced even after the elapse of a long time at a high temperature, and at the same time, the surface covering layer constituents according to this embodiment are employed, so that excellent fretting wear resistance can be imparted to the conductive material for connecting parts.

### (2) Composition of Copper Alloy

The copper alloy according to this embodiment contains one member or two members of Cr: from 0.15 to 0.70 mass % and Zr: from 0.01 to 0.20 mass %, with a remainder being Cu and an unavoidable impurity. The copper alloy preferably further contains Ti: from 0.01 to 0.30 mass % and/or Si: from 0.01 to 0.20 mass %.

Cr enhances the strength of the copper alloy through precipitation hardening by a simple Cr particle or a compound particle such as Cr—Si, Cr—Ti or Cr—Si—Ti together with Si and Ti. This precipitation leads to a decrease in the amounts of Cr, Si and Ti dissolved in the Cu matrix and an elevation of the electrical conductivity of the copper alloy. If the Cr content is less than 0.15 mass %, neither the strength is sufficiently increased by the precipitation nor the resistance to stress relaxation is enhanced. On the other hand, if the Cr content exceeds 0.7 mass %, coarsening of a precipitate is caused, and the resistance to stress relaxation and the bendability are reduced. Accordingly, the Cr content is set to the range of 0.15 to 0.7 mass %. The lower limit of the Cr content is preferably 0.20 mass %, more preferably 0.25 mass %, and the upper limit is preferably 0.6 mass %, more preferably 0.50 mass %.

Zr forms an intermetallic compound with Cu and Si and enhances the strength and resistance to stress relaxation of the copper alloy through precipitation hardening. This precipitation leads to a decrease in the amounts of Si and Ti dissolved in the Cu matrix and an elevation of the electrical conductivity of the copper alloy. In addition, Zr has an action/effect of refining the crystal grain of the Cu matrix. If the Zr content is less than 0.01 mass %, the effects above are not sufficiently obtained. In addition, if it exceeds 0.20 mass %, a coarse compound is formed, and the resistance to stress relaxation and the bendability are reduced. Accordingly, the Zr content is set to the range of 0.01 to 0.20 mass %. The lower limit of the Zr content is preferably 0.015 mass %, more preferably 0.02 mass %, and the upper limit is preferably 0.18 mass %, more preferably 0.15 mass %.

Ti has an effect of enhancing the strength, softening resistance and resistance to stress relaxation of the copper alloy by dissolving in the Cu matrix. In addition, Ti forms a precipitate together with Cr and Si and enhances the strength of the copper alloy through precipitation hardening. This precipitation leads to a decrease in the amounts of Cr, Si and Ti dissolved in the Cu matrix and an elevation of the electrical conductivity of the copper alloy. If the Ti content is less than 0.01 mass %, the copper alloy is low in the softening resistance and is softened in the annealing step, making it difficult to obtain high strength. Furthermore, the resistance to stress relaxation of the copper alloy cannot be enhanced. On the other hand, if the Ti content exceeds 0.30 mass %, the amount of Ti dissolved in the Cu matrix is increased to cause reduction in the electrical conductivity. Accordingly, the Ti content is set to the range of 0.01 to 0.30 mass %. The lower limit of the Ti content is preferably 0.02 mass %, more preferably 0.03 mass %, and the upper limit is preferably 0.25 mass %, more preferably 0.20 mass %.

Si forms a compound such as Cr—Si, Zr—Si, Ti—Si, or Cr—SiTi together with Cr, Zr and Ti and enhances the strength of the copper alloy through precipitation hardening. This precipitation leads to a decrease in the amounts of Cr, Zr, Si, and Ti dissolved in the Cu matrix and an elevation of the electrical conductivity. If the Si content is less than 0.01 mass %, the strength is not sufficiently enhanced by a precipitate such as Cr—Si, Zr—Si, Ti—Si, or Cr—Si—Ti. On the other hand, if the Si content exceeds 0.20 mass %, the amount of Si dissolved in the Cu matrix is increased to reduce the electrical conductivity. In addition, the precipitate is coarsened, and the bendability and the resistance to stress relaxation are reduced. Accordingly, the Si content is set to the range of 0.01 to 0.20 mass %. The lower limit of the Si content is preferably 0.015 mass %, more preferably 0.02 mass %, and the upper limit is preferably 0.15 mass %, more preferably 0.10 mass %.

The copper alloy further contains, if desired, 1.0 mass % or less in total of one or more members of Zn: from 0.001 to 1.0 mass %, Sn: from 0.001 to 0.5 mass %, Mg: from 0.001 to 0.15 mass %, Ag: from 0.005 to 0.50 mass %, Fe: from 0.005 to 0.50 mass %, Ni: from 0.005 to 0.50 mass %, Co: from 0.005 to 0.50 mass %, Al: from 0.005 to 0.10 mass %, and Mn: from 0.005 to 0.10 mass %. All of these elements enhance the strength of the copper alloy, but if the total content of these elements exceeds 1.0 mass %, the electrical conductivity of the copper alloy becomes poor.

These elements have the following effects, in addition to the strength enhancing effect.

Zn is an element effective in improving the thermal peel resistance of Sn plating or solder used for joining of electronic parts. If the Zn content is less than 0.001 mass %, the effect above is not obtained, and if it exceeds 1.0 mass %, the electrical conductivity of the copper alloy decreases. Accordingly, the Zn content is set to the range of 0.001 to 1.0 mass %. The lower limit of the Zn content is preferably 0.01 mass %, more preferably 0.1 mass %, and the upper limit is preferably 0.8 mass %, more preferably 0.6 mass %. Sn and Mg are effective in enhancing the stress relaxation property. In addition, Mg has a desulfurizing action and improves the hot workability. However, if the content of each of the elements Sn and Mg is less than 0.001 mass %, the effect is low in both cases. On the other hand, if the content of each element Sn exceeds 0.5 mass % or if the Mg content exceeds 0.15 mass %, the electrical conductivity of the copper alloy decreases. Accordingly, the Sn content is set to the range of 0.001 to 0.5 mass %, and the Mg content is set to the range of 0.001 to 0.15%. The lower limit of the Sn content is preferably 0.005 mass %, more preferably 0.01 mass %, and the upper limit is preferably 0.40 mass %, more preferably 0.30 mass %. The lower limit of the Mg content is preferably 0.005 mass %, more preferably 0.01 mass %, and the upper limit is preferably 0.10 mass %, more preferably 0.05 mass %.

Ag has an action of enhancing the softening resistance and stress relaxation property of the copper alloy by dissolving in the Cu matrix. If the Ag content is less than 0.005 mass %, the effect above is small, and if it exceeds 0.5 mass %, the effect is saturated. Accordingly, the Ag content is set to 0.005 to 0.50 mass %. The lower limit of the Ag content is preferably 0.01 mass %, more preferably 0.015 mass %, and the upper limit is preferably 0.30 mass %, more preferably 0.20 mass %.

Fe, Ni and Co have an action of enhancing the conductive property of the copper alloy by precipitating a compound with Si, but if the content thereof is large, the solid-solution amount is increased to deteriorate the conductive property. The content of each of Fe, Ni and Co is set to 0.005 to 0.50 mass %. The lower limit of these elements is preferably 0.01 mass %, more preferably 0.03 mass %, and the upper limit is preferably 0.40 mass %, more preferably 0.30 mass %.

Al and Mn have a desulfurizing action and improve the hot workability. However, if the content of Al or Mn is less than 0.005 mass %, the effect is low. On the other hand, if the content of Al or Mn exceeds 0.1 mass %, the electrical conductivity of the copper alloy decreases. The lower limit of these elements is preferably 0.01 mass %, more preferably 0.02 mass %, and the upper limit is preferably 0.08 mass %, more preferably 0.06 mass %.

Here, the compositions of the above-described Cu—Cr, Cu—Cr—Ti, Cu—Zr, and Cu—Cr—Zr alloys are known per se.

The unavoidable impurity of the copper alloy includes As, Sb, B, Pb, V, Mo, Hf, Ta, Bi, In, H, and O.

With respect to As, Sb, B, Pb, V, Mo, Hf, Ta, Bi, and In, if the total content thereof exceeds 0.5 mass %, segregation in a grain boundary or formation of a crystallized dispersoid occurs to deteriorate the resistance to stress relaxation and the bendability. Accordingly, the content of these elements in the copper alloy is preferably 0.5 mass % or less in total, more preferably 0.1 mass % or less in total.

H is absorbed into a molten metal from a raw material or from the atmosphere in a melting and casting step. If the H content in the molten metal is large, H is discharged as H₂ gas during solidification to form a blowhole inside an ingot or is concentrated in a grain boundary of the ingot to reduce the strength of the grain boundary of the ingot. When such an ingot is heated up to a predetermined temperature and hot-rolled, internal cracking occurs during heating or hot rolling, and the hot workability deteriorates. Even if hot cracking is not caused, bulging occurs on the plate surface in the subsequent thermo-mechanical treatment step to reduce the yield of a product. Accordingly, the H content in the copper alloy is preferably 0.0002 mass % or less. The H content is more preferably 0.00015 mass % or less, still more preferably 0.0001 mass % or less.

The copper alloy according to this embodiment contains one or more of Cr and Zr having large affinity for O, preferably further contains Ti, and is therefore susceptible to oxidation in a melting and casting step. The oxide entrapped in the ingot causes a problem such as cracking of ingot during hot rolling, surface flaw during cold rolling, and reduction in bendability of a thin plate. Accordingly, the O content in the copper alloy is preferably 0.0030 mass % or less. The O content is more preferably 0.0020 mass % or less, still more preferably 0.001 mass % or less.

Here, an increase in the contents of H, O, S, and C leads to not only a reduction of hot workability of an ingot but also, although the reason therefor is unknown, a decrease in the stress relaxation rate particularly at a temperature of 160° C. or more, and in order not to decrease the stress relaxation rate, it is necessary to control ([O]+[S]+[C])×[H]² to be 40 or less ([O], [S], [C], and [H] are the contents (unit: ppm by mass) of respective elements). ([O]+[S]+[C])×[H]² is more preferably 30 or less.

### (3) Production Method of Copper Alloy Strip

The Cu—Cr, Cu—Zr and Cu—Cr—Zr alloy strips are usually produced by applying homogenization treatment, hot rolling, cold rolling, and precipitation heat treatment to an ingot obtained through melting and casting. This production process need not be greatly changed even in the case of the copper alloy strip of this embodiment.

In the melting and casting of a copper alloy, in order to prevent absorption of H and O into the molten metal, it is preferable to implement a countermeasure such as drying raw materials, inert gas sealing (e.g., nitrogen, argon) on melting furnaces, or inert gas sealing between the melting furnace and the casting mold. Furthermore, in order to prevent absorption of H and O into the molten metal, the molten metal temperature in the melting and casting step is preferably set to 1,250° C. or less and preferably 1,200° C. or less. It is effective for preventing absorption of S and C into the molten metal to reduce the oil content adhering to the raw material used, and before adding elements such as Zr, Cr and Ti, to perform desulfurization by the addition of an element readily forming a sulfide, such as Ca, Mg, Zr, to the molten metal or to perform deoxidation by the addition of an element readily forming an oxide, such as Al and Zr, to the molten metal.

The homogenization treatment is performed at 800 to 1,000° C. for 0.5 hours or more. The hot rolling after the homogenization treatment is performed at a reduction of 60% or more, and quenching is then performed at a temperature of 700° C. or more. If the quenching is performed in a temperature range lower than 700° C., a coarse precipitate is readily produced, and the resistance to stress relaxation and the bendability are reduced.

Successively, the hot-rolled material is cold-rolled to a desired thickness and then subjected to precipitation heat treatment. Cold rolling may be further performed after the precipitation heat treatment, and stress relief annealing may be further performed after this cold rolling. In place of the process of hot rolling-cold rolling-precipitation heat treatment, a process of hot rolling-cold rolling-solution treatment-cold rolling-precipitation heat treatment may be employed. The solution treatment is for re-dissolving a Cr-containing precipitate formed during quenching after hot rolling and is conducted under the conditions of 750 to 850° C. and 30 seconds or more, and within this range, the conditions allowing the grain size after the solution treatment to become larger than the grain size after the completion of hot rolling are preferably selected. The precipitation heat treatment is for precipitating a simple Cr precipitate or a compound precipitate such as Cu—Zr, Cr—Si and Cr—Si—Ti and is conducted under the conditions of 400 to 550° C. and 2 hours or more, and within this range, a temperature providing as high hardness as possible and an elongation of 10% or more is preferably selected.

### [Surface Covering Layer]

### (1) Cu Content in Cu—Sn Alloy Covering Layer

The Cu content in the Cu—Sn alloy covering layer is from 20 to 70 at %, as with the conductive material for connecting parts described in Patent Document 2. The Cu—Sn alloy covering layer having a Cu content of 20 to 70 at % contains an intermetallic compound mainly composed of a Cu₆Sn₅ phase. In the present invention, the Cu₆Sn₅ phase partially projects into the surface of the Sn covering layer, and the hard Cu₆Sn₅ phase can therefore receive the contact pressure during sliding of electrical contact points to further reduce the contact area between Sn covering layers, as a result, the wear or oxidation of the Sn covering layer also decreases. Meanwhile, a Cu₃Sn phase has a large Cu content compared with the Cu₆Sn₅ phase and therefore, if this phase is partially exposed at the surface of the Sn covering layer, for example, the amount of Cu oxide on the material surface is increased due to aging, corrosion, etc., making it likely for the contact resistance to increase, as a result, the reliability of electrical connection can be hardly maintained. In addition, the Cu₃Sn phase is brittle compared with the Cu₆Sn₅ phase and is therefore disadvantageously poor in formability, etc. Accordingly, the constituent component of the Cu—Sn alloy covering layer is specified to be a Cu—Sn alloy having a Cu content of 20 to 70 at %. The Cu—Sn alloy covering layer may partially contain a Cu₃Sn phase and may contain a constituent element, etc. of the matrix and Sn plating. However, if the Cu content of the Cu—Sn alloy covering layer is less than 20 at %, the adhesion amount increases, and the fretting wear resistance decreases. On the other hand, if the Cu content exceeds 70 at %, the reliability of electrical connection can be hardly maintained due to aging, corrosion, etc., and the formability, etc. are also deteriorated. Accordingly, the Cu content in the Cu—Sn alloy covering layer is specified to be from 20 to 70 at %. The lower limit of the Cu content in the Cu—Sn alloy covering layer is preferably 45 at %, and the upper limit is preferably 65 at %.

### (2) Average Thickness of Cu—Sn Alloy Covering Layer

The average thickness of the Cu—Sn alloy covering layer is from 0.2 to 3.0 μm, as with the conductive material for connecting parts described in Patent Document 2. In the present invention, the average thickness of the Cu—Sn alloy covering layer is defined as a value obtained by dividing an area density (unit: g/mm²) of Sn contained in the Cu—Sn alloy covering layer by a density (unit: g/mm³) of Sn. The method for measuring the average thickness of the Cu—Sn alloy covering layer described in Examples later is in conformity with the definition above. If the average thickness of the Cu—Sn alloy covering layer is less than 0.2 μm, in the case of forming the Cu—Sn alloy covering layer to be partially exposed at the material surface as in the present invention, the amount of Cu oxide in the material surface increases due to thermal diffusion such as high-temperature oxidation. When the amount of Cu oxide in the material surface is increased, the contact resistance is likely to increase, and the reliability of electrical connection can be hardly maintained. On the other hand, if it exceeds 3.0 μm, economical disadvantage and poor productivity are caused and since a hard layer is thickly formed, the formability, etc. are deteriorated. Accordingly, the average thickness of the Cu—Sn alloy covering layer is specified to be from 0.2 to 3.0 μm. The lower limit of the average thickness of the Cu—Sn alloy covering layer is preferably 0.3 μm, and the upper limit is preferably 1.0 μm.

### (3) Average Thickness of Sn Covering Layer

The average thickness of the Sn covering layer is from 0.05 to 5.0 μm. This range is slightly wide in the small-thickness direction, compared with the average thickness (from 0.2 to 5.0 μm) of the Sn covering layer in the conductive material for connecting parts described in Patent Document 2. If the average thickness of the Sn covering layer is less than 0.2 μm, as described in Patent Document 2, the amount of Cu oxide in the material surface is increased due to thermal diffusion such as high-temperature oxidation, and not only the contact resistance is likely to increase but also the corrosion resistance is deteriorated. On the other hand, the friction coefficient is lowered, and a great reduction in insertion force can be realized. However, if the average thickness of the Sn covering layer is further smaller and becomes less than 0.05 μm, the lubrication effect of soft Sn is not exerted, and the friction coefficient rather rises. If the average thickness of the Sn covering layer exceeds 5.0 μm, not only the friction coefficient rises due to adhesion of Sn but also economical disadvantage and poor productivity are caused. Accordingly, the average thickness of the Sn covering layer is specified to be from 0.05 to 5.0 μm. Among others, it is preferably 0.2 μm or more in applications placing importance on low contact resistance and high corrosion resistance and is preferably less than 0.2 μm in applications placing importance on low friction coefficient. The lower limit of the average thickness of the Sn covering layer is preferably 0.07 μm, more preferably 0.10 μm, and the upper limit is preferably 3.0 μm, more preferably 1.5 μm.

In the case where the Sn covering layer is composed of an Sn alloy, the constituent components except for Sn of the Sn alloy include Pb, Bi, Zn, Ag, Cu, etc. Pb is preferably less than 50 mass %, and the other elements are preferably less than 10 mass %.

### (4) Arithmetic Mean Roughness Ra of Material Surface

As with the conductive material for connecting parts described in Patent Document 2, the arithmetic mean roughness Ra in at least one direction of the material surface is 0.15 μm or more, and the arithmetic mean roughness Ra in all directions is 3.0 μm or less. If the arithmetic mean roughness Ra in all directions is less than 0.15 μm, the projection height of the Cu—Sn alloy covering layer into the material surface is totally low, and the rate at which the hard Cu₆Sn₅ phase receives the contact pressure during sliding of electrical contact points is reduced, especially making it difficult to decrease the depth of wear of the Sn covering layer due to fretting. On the other hand, if the arithmetic mean roughness Ra exceeds 3.0 μm in any direction, the amount of Cu oxide in the material surface is increased due to thermal diffusion such as high-temperature oxidation, and the contact resistance is likely to increase, as a result, the reliability of electrical connection can be hardly maintained. Accordingly, the surface roughness of the matrix is specified such that the arithmetic mean roughness Ra in at least one direction is 0.15 μm or more and the arithmetic mean roughness Ra in all directions is 3.0 μm or less. Preferably, the arithmetic mean roughness Ra in at least one direction is 0.2 μm or more, and the arithmetic mean roughness Ra in all directions is 2.0 μm or less.

### (5) Exposed Area Ratio of Cu—Sn Alloy Covering Layer on Surface of Conductive Material

The exposed area ratio of the Cu—Sn alloy covering layer on the surface of the conductive material is from 3 to 75%, as with the conductive material for connecting parts described in Patent Document 2. Here, the exposed area ratio of the Cu—Sn alloy covering layer on the surface of the conductive material is calculated as a value obtained by multiplying the surface area of the Cu—Sn alloy covering layer exposed per unit surface area of the material by 100. If the exposed area ratio of the Cu—Sn alloy covering layer on the surface of the conductive material is less than 3%, the amount of adhesion between Sn covering layers is increased to reduce the fretting wear resistance and increase the depth of wear of the Sn covering layer. On the other hand, if it exceeds 75%, for example, the amount of Cu oxide in the material surface is increased due to aging, corrosion, etc., and the contact resistance is likely to increase, as a result, the reliability of electrical connection can be hardly maintained. Accordingly, the exposed area ratio of the Cu—Sn alloy covering layer on the surface of the conductive material is specified to be from 3 to 75%. Preferably, the lower limit is 10%, and the upper limit is 50%.

### (6) Average Grain Size in Cu—Sn Alloy Covering Layer Surface

The average grain size in the Cu—Sn alloy covering layer surface is less than 2 μm. When the average grain size in the Cu—Sn alloy covering layer surface is small, the hardness of the Cu—Sn alloy covering layer surface and the apparent hardness of the Sn covering layer present on the Cu—Sn alloy covering layer are increased, and the dynamic friction coefficient becomes further smaller. In addition, since the hardness of the Cu—Sn alloy covering layer surface is increased, the Cu—Sn alloy layer is less likely to be deformed or broken during sliding of terminals, and the fretting wear resistance is enhanced.

Furthermore, when the average grain size in the Cu—Sn alloy covering layer surface becomes small, microscopic unevenness on the surface of the Cu—Sn alloy covering layer is reduced, and the contact area between the exposed Cu—Sn alloy covering layer and the counterpart terminal increases. In turn, the adhesion force between the Cu—Sn alloy covering layer and the Cu—Sn alloy covering layer or Sn covering layer of the counterpart terminal becomes large, increasing the static coefficient of friction in the terminal, and terminals are less likely to be moved with each other even when vibration or thermal expansion/contraction acts between terminals, as a result, the fretting wear resistance is enhanced.

Accordingly, the average grain size in the Cu—Sn alloy covering layer surface is set to be less than 2 μm, preferably 1.5 μm or less, more preferably 1.0 μm or less. Here, as demonstrated in Examples later, in the conductive material for connecting parts obtained under the reflowing conditions regarded to be preferable in Patent Document 2, the average grain size in the Cu—Sn alloy covering layer surface exceeds 2 μm.

### (7) Average Material Surface Exposure Interval of Cu—Sn Alloy Covering Layer

The average material surface exposure interval of the Cu—Sn alloy covering layer in at least one direction is preferably from 0.01 to 0.5 mm, as with the conductive material for connecting parts described in Patent Document 2. Here, the average material surface exposure interval of the Cu—Sn alloy covering layer is defined as a value obtained by adding the average width of the Cu—Sn alloy covering layer traversing a straight line drawn on the material surface (the length along the straight line) to the average width of the Sn covering layer. If the average material surface exposure interval of the Cu—Sn alloy covering layer is less than 0.01 mm, the amount of Cu oxide in the material surface is increased due to thermal diffusion such as high-temperature oxidation, and the contact resistance is likely to increase, as a result, the reliability of electrical connection can be hardly maintained. On the other hand, if it exceeds 0.5 mm, it may be sometimes difficult to obtain a low friction coefficient particularly when used for a small terminal. In general, when a terminal is miniaturized, the contact area between electrical contact points (insertion/withdrawal parts), such as indentations and ribs, becomes small and in turn, the probability that only Sn covering layers are put into contact with each other during insertion/withdrawal increases. As a result, the amount of a Sn adhesion is increased, making it difficult to obtain a low friction coefficient. Accordingly, the average material surface exposure interval of the Cu—Sn alloy covering layer is preferably set to be from 0.01 to 0.5 mm in at least one direction. More preferably, the average material surface exposure interval of the Cu—Sn alloy covering layer is set to be from 0.01 to 0.5 mm in all directions. By this setting, the probability that only Sn covering layers are put into contact with each other during insertion/withdrawal decreases. The lower limit is preferably 0.05 mm, and the upper limit is preferably 0.3 mm.

### (8) Thickness of Cu—Sn Alloy Covering Layer Exposed at Surface

In the conductive material for connecting parts according to this embodiment, the thickness of the Cu—Sn alloy covering layer exposed at the surface is preferably 0.2 μm or more, as with the conductive material for connecting parts described in Patent Document 2. This is because, in the case of partially exposing the Cu—Sn alloy covering layer at the surface of the Sn covering layer as in the present invention, depending on the production conditions, the thickness of the Cu—Sn alloy covering layer exposed at the surface of the Sn covering layer may become very small compared with the average thickness of the Cu—Sn alloy covering layer.

Here, the thickness of the Cu—Sn alloy covering layer exposed at the surface of the Sn covering layer is defined as a value measured by cross-sectional observation (this differs from the above-described method for measuring the average thickness of the Cu—Sn alloy covering layer). If the thickness of the Cu—Sn alloy covering layer exposed at the surface of the Sn covering layer is less than 0.2 μm, a fretting wear phenomenon is likely to occur at an early stage. In addition, the amount of Cu oxide in the material surface is increased due to thermal diffusion such as high-temperature oxidation, and the corrosion resistance is reduced, making it likely for the contact resistance to increase, as a result, the reliability of electrical connection can be hardly maintained. Accordingly, the thickness of the Cu—Sn alloy covering layer exposed at the surface of the Sn covering layer is preferably set to be 0.2 μm or more, more preferably 0.3 μm or more.

(9) Sn Plating Layer Formed after Reflow Processing

The average thickness of the Sn plating layer formed on the surface of the conductive material for connecting parts after the reflow processing is from 0.02 to 0.2 μm. The conductive material for connecting parts, on which a Sn plating layer is formed, exhibits enhanced solder wettability and is therefore suited for the production of a terminal having a solder junction. The Sn plating may be any of bright Sn plating, matt Sn plating, and semi-bright Sn plating providing a glossiness intermediate therebetween. If the average thickness of the Sn plating layer is less than 0.02 μm, the solder wettability-enhancing effect is low, whereas if it exceeds 0.2 μm, the friction coefficient rises and the fretting wear resistance is reduced. The average thickness of the Sn plating layer is preferably 0.03 μm or more, more preferably 0.05 μm or more.

The Sn plating layer is preferably formed in a uniform thickness all over the surface after the reflow processing, but the platability of Sn plating differs between the Cu—Sn alloy covering layer exposed at the surface after the reflow processing and the Sn covering layer (more easily plated on the latter than on the former). Accordingly, an undeposited part of Sn plating is sometimes present partially in the exposed region of the Cu—Sn alloy covering layer.

### (10) Other Surface Covering Layer Constituents

(a) As with the conductive material for connecting parts described in Patent Document 2, a Cu covering layer may be provided between the matrix and the Cu—Sn alloy covering layer. The Cu covering layer is a Cu plating layer remaining after reflow processing. It is widely known that the Cu covering layer is useful in preventing Zn or other matrix constituent elements from diffusing to the material surface and the solderability, etc. are thereby improved. If the Cu covering layer is too thick, the formability, etc. are deteriorated, and the profitability also becomes poor. For this reason, the thickness of the Cu covering layer is preferably 3.0 μm or less.

In the Cu covering layer, a small amount of component elements, etc. contained in the matrix may get mixed with. In the case where the Cu covering layer is composed of a Cu alloy, the constituent component other than Cu of the Cu alloy includes Sn, Zn, etc. The content is preferably less than 50 mass % in the case of Sn and less than 5 mass % for other elements.

(b) As with the conductive material for connecting parts described in Patent Document 2, a Ni covering layer may be formed as an undercoat layer between the matrix and the Cu—Sn alloy covering layer (in the case of not having a Cu covering layer) or between the matrix and the Cu covering layer. The Ni covering layer is known to prevent Cu and matrix constituent elements from diffusing to the material surface, thereby suppressing an elevation of the contact resistance even after operating at a high temperature for a long time, prevent depletion of the Sn at the Sn covering layer by restraining growth of the Cu—Sn alloy covering layer, and bring about enhancement of the sulfurous acid gas corrosion resistance. Diffusion of the Ni covering layer itself to the material surface is prevented by the Cu—Sn alloy covering layer or the Cu covering layer. For this reason, the connecting part material having formed thereon a Ni covering layer is particularly suitable for a connecting part requiring thermal diffusion resistance. However, if the average thickness of the Ni covering layer is less than 0.1 μm, the effects above may not be sufficiently exerted, for example, due to increase in the number of pit defects in the Ni covering layer. Accordingly, the average thickness of the Ni covering layer is preferably 0.1 μm or more. On the other hand, if the Ni covering layer is too thick, the formability, etc. are deteriorated, and the profitability also becomes poor. The average thickness of the Ni covering layer is therefore preferably 3.0 μm or less. The average thickness of the Ni covering layer preferably has a lower limit of 0.2 μm and an upper limit of 2.0 μm.

In the Ni covering layer, a small amount of component elements, etc. contained in the matrix may get mixed with. In the case where the Ni covering layer is composed of an Ni alloy, the constituent component other than Ni of the Ni alloy includes Cu, P, Co, etc. The content is preferably 40 mass % or less for Cu and 10 mass % or less for P and Co.

(c) In place of the Ni covering layer, a Co covering layer or a Fe covering layer may be used as the undercoat layer. The Co covering layer contains Co or a Co alloy, and the Fe covering layer contains Fe or a Fe alloy.

The Co covering layer or Fe covering layer prevents the matrix constituent elements from diffusing to the material surface, as with the Ni covering layer. Accordingly, it is useful to prevent depletion of the Sn at the Sn layer by restraining growth of the Cu—Sn alloy covering layer and suppress an elevation of the contact resistance even after use at a high temperature for a long time as well as to obtain good solder wettability. If the average thickness of the Co covering layer or Fe covering layer is less than 0.1 μm, as with the Ni covering layer, the effects above may not be sufficiently exerted, for example, due to increase in the number of pit defects in the Co covering layer or Fe covering layer. In addition, if the Co covering layer or Fe covering layer is thick and has an average thickness of more than 3.0 μm, as with the Ni covering layer, the effects above are saturated, or the formability into a terminal is reduced to cause, for example, cracking during bending, and the productivity and profitability turn worse. Accordingly, in the case of using, as the undercoat layer, a Co covering layer or a Fe covering layer in place of the Ni covering layer, the average thickness of the Co covering layer or Fe covering layer is set to be from 0.1 to 3.0 μm. The average thickness of the Co covering layer or Fe covering layer preferably has a lower limit of 0.2 μm and an upper limit of 2.0 μm.

(d) Any two out of a Ni covering layer, a Co covering layer and a Fe covering layer can be used as the undercoat layer. In this case, it is preferable to form a Co covering layer or a Fe covering layer between the matrix surface and the Ni covering layer or between the Ni covering layer and the Cu—Sn alloy layer. For the same reason as in the case where the undercoat layer is only a Ni covering layer, only a Co covering layer or only a Fe covering layer, the total average thickness of two undercoat layers (any two out of Ni covering layer, Co covering layer and Fe covering layer) is from 0.1 to 3.0 μm. The total average thickness preferably has a lower limit of 0.2 μm and an upper limit of 2.0

### [Production Method of Conductive Material for Connecting Parts]

The conductive material for connecting parts of the present invention is produced by applying a roughening treatment to a surface of a copper alloy matrix, and forming a Sn plating layer on the matrix surface directly or on a Ni plating layer (or Co plating or Fe plating) and a Cu plating layer, followed by reflow processing. The steps in this production method are the same as in the production method of a conductive material for connecting parts described in Patent Document 2.

The method for roughening treatment of the matrix surface includes a physical method such as ion etching, a chemical method such as etching and electrolytic polishing, and a mechanical method such as rolling (using a work roll roughened by grinding, shot blast, etc.), grinding and shot blast. Among these, rolling and grinding are preferred as a method excellent in the productivity, profitability and reproducibility of the matrix surface morphology.

In the case where the Ni plating layer, Cu plating layer and Sn plating layer are composed of a Ni alloy, Cu alloy and Sn alloy, respectively, alloys described above regarding each of the Ni covering layer, the Cu covering layer and the Sn covering layer may be used.

The average thickness of the Ni plating layer is preferably in the range of 0.1 to 3 μm, the average thickness of the Cu plating layer is preferably in the range of 0.1 to 1.5 μm, and the average thickness of the Sn plating layer is preferably in the range of 0.4 to 8.0 μm. In the case of not forming a Ni plating layer, it is also possible not to form a Cu plating layer at all.

Cu in the Cu plating layer or the copper alloy matrix and Sn in the Sn plating layer are caused to mutually diffuse by reflow processing, whereby the Cu—Sn alloy covering layer is formed. At this time, there can be both a case where the Cu plating layer entirely disappears, and a case where it partially remains.

As with the conductive material for connecting parts described in Patent Document 2, the matrix surface roughness after roughening treatment is preferably such that the arithmetic mean roughness Ra in at least one direction is 0.3 μm or more and the arithmetic mean roughness Ra in all directions is 4.0 μm or less. If the arithmetic mean roughness Ra is less than 0.3 μm in all directions, the conductive material for connecting parts of this embodiment can be hardly produced. Specifically, it is difficult to satisfy the requirement that the arithmetic mean roughness Ra in at least one direction on the material surface after reflow processing is 0.15 μm or more, the exposed area ratio of the Cu—Sn alloy covering layer on the surface of the conductive material is from 3 to 75%, and at the same time, the average thickness of the Sn covering layer is from 0.05 to 5.0 μm. On the other hand, if the arithmetic mean roughness Ra exceeds 4.0 μm in any direction, it is difficult to smooth the Sn covering layer surface by a flowing effect of molten Sn or Sn alloy. Accordingly, the surface roughness of the matrix is set such that the arithmetic mean roughness Ra in at least one direction is 0.3 μm or more and the arithmetic average roughness Ra in all directions is 4.0 μm or less. By achieving this surface roughness, along with the flowing effect of molten Sn or Sn alloy (smoothing of the Sn coating layer), part of the Cu—Sn alloy covering layer grown by reflow processing is exposed at the material surface. The surface roughness of the matrix is preferably such that the arithmetic mean roughness Ra in at least one direction is 0.4 μm or more and the arithmetic average roughness Ra in all directions is 3.0 μm or less.

As with the conductive material for connecting parts described in Patent Document 2, the average interval Sm between projections and depressions as calculated in the one direction on the matrix surface is preferably from 0.01 to 0.5 mm. A Cu—Sn diffusion layer formed between the Cu plating layer or the copper alloy matrix and the molten Sn plating layer by reflow processing usually grows by reflecting the surface morphology of the matrix. Therefore, the material surface exposure interval of the Cu—Sn alloy covering layer formed by reflow processing approximately reflects the average interval Sm between projections and depressions on the matrix surface. Accordingly, the average interval Sm between projections and depressions as calculated in the one direction on the matrix surface is preferably from 0.01 to 0.5 mm. More preferably, the lower limit is 0.05 mm, and the upper limit is 0.3 mm. By satisfying this requirement, the exposure morphology of the Cu—Sn alloy covering layer exposed at the material surface can be controlled.

In Patent Document 2, as for reflow processing conditions, it is stated that it is preferably performed at a temperature of 600° C. or less for 3 to 30 seconds and, among others, preferably performed with, particularly, as small a heat quantity as possible at 300° C. or less, and in Examples, the processing is performed mainly under the conditions of 280° C.×10 seconds. In paragraph 0035 of Patent Document 2, it is stated that the grain size of the Cu—Sn alloy covering layer obtained under the reflow processing conditions above is from several μm to tens of μm.

On the other hand, according to the knowledge of the present inventors, in order to more reduce the grain size of the Cu—Sn alloy covering layer to less than 2 μm, the temperature rise rate during reflow processing needs to be increased. The temperature rise rate of the matrix can be increased by increasing the heat quantity applied to the material during reflow processing, i.e., by adjusting the ambient temperature in the reflowing furnace to be high in raising the temperature. The temperature rise rate is preferably 15° C./sec or more, more preferably 20° C./sec or more. In Patent Document 2, since it is said that the grain size of the Cu—Sn alloy covering layer is from several μm to tens of μm, the temperature rise rate during reflow processing is presumed to be approximately from 8 to 12° C./sec or lower than that.

The reflow processing temperature as an actual temperature is preferably 400° C. or more, more preferably 450° C. or more. On the other hand, in order to keep the Cu content of the Cu—Sn alloy covering layer from becoming excessively high, the reflow processing temperature is preferably 650° C. or less, more preferably 600° C. or less. The time of holding at the reflow processing temperature above (reflow processing time) is approximately from 5 to 30 seconds and is preferably shorter as the reflow processing temperature is higher. After reflow processing, rapid cooling is performed by immersing in water according to a conventional manner.

By performing the reflow processing under these conditions, a Cu—Sn alloy covering layer having a small grain size is formed, and a Cu—Sn alloy covering layer having a Cu content of 20 to 70 at % is formed. In addition, a Cu—Sn alloy covering layer having a thickness of 0.2 μm or more is exposed at the surface, and excessive depletion of the thickness of the Sn plating layer is suppressed.

After reflow processing, a Sn plating layer having an average thickness of 0.02 to 0.2 μm is formed, if desired, on the surface of the conductive material for connecting parts. This Sn plating may be any of bright Sn plating, matt Sn plating, and semi-bright Sn plating providing a glossiness intermediate therebetween.

### Embodiment B

The embodiment corresponding to claim 3 of the present invention is described below.

### [Copper Alloy Matrix]

### (1) Composition of Cu—Fe—P Alloy

The copper alloy strip according to this embodiment is a Cu—Fe—P alloy containing Fe: from 0.01 to 2.6 mass % and P: from 0.01 to 0.3 mass %, with a remainder being Cu and an unavoidable impurity.

Fe precipitates as a simple Fe particle or a Fe-based intermetallic compound particle and is a main element for enhancing the strength and softening resistance of the copper alloy. If the Fe content is less than 0.01 mass %, the amount of a precipitate produced is small and although enhancement of electrical conductivity may be satisfied, the contribution to strength enhancement is insufficient, resulting in a lack of strength. On the other hand, if the Fe content exceeds 2.6 mass %, the electrical conductivity is likely to decrease and when the precipitation amount is increased so as to increase the electrical conductivity, conversely, growth/coarsening of the precipitate is caused to reduce the strength and bendability. Accordingly, the Fe content is set to the range of 0.01 to 2.6 mass %. The lower limit of the Fe content is preferably 0.03 mass %, more preferably 0.06 mass %, and the upper limit is preferably 2.5 mass %, more preferably 2.3 mass %.

P has a deoxidizing effect and is a main element for increasing the strength of the copper alloy by forming a compound with Fe. If the P content is less than 0.01 mass %, depending on the production conditions, the amount of a precipitate produced may be small, and a desired strength cannot be obtained. On the other hand, if the P content exceeds 0.3 mass %, not only the conductive property is reduced but also the hot workability is reduced. Accordingly, the P content is set to the range of 0.01 to 0.3 mass %. The lower limit of the P content is preferably 0.03 mass %, more preferably 0.05 mass %, and the upper limit is preferably 0.25 mass %, more preferably 0.2 mass %.

The Cu—Fe—P alloy may further contain one member or two members of Sn: from 0.001 to 0.5 mass % and Zn: from 0.005 to 3.0 mass %, if desired.

Zn improves the thermal peel resistance of solder plating of the Cu—Fe—P alloy and Sn plating. If the Zn content is less than 0.005 mass %, the desired effect cannot be obtained. On the other hand, if the Zn content exceeds 3.0 mass %, not only the solder wettability decreases but also reduction in the electrical conductivity increases. Accordingly, the Zn content is set to be from 0.005 to 3.0%. The lower limit of the Zn content is preferably 0.01 mass %, more preferably 0.03 mass %, and the upper limit is preferably 2.5 mass %, more preferably 2.0 mass %.

Sn contributes to strength enhancement of the Cu—Fe—P alloy. If the Sn content is less than 0.001 mass %, the element does not contribute to increasing the strength. On the other hand, if the Sn content is increased to exceed 0.5 mass %, the effect is saturated, and conversely, not only reduction in the electrical conductivity is caused but also bendability is deteriorated. In order to make the strength and electrical conductivity of the copper alloy to fall in desired ranges, the Sn content is set to the range of 0.001 to 0.5 mass %. The lower limit of the Sn content is preferably 0.01 mass %, more preferably 0.05 mass %, and the upper limit is preferably 0.4 mass %, more preferably 0.3 mass %.

The Cu—Fe—P alloy may further contain one member or two or more members of group A elements (Mn, Mg and Ca) or/and one member or two or more members of the group B elements (Zr, Ag, Cr, Cd, Be, Ti, Si, Co, Ni, Al, Au, and Pt), if desired.

The group A element contributes to enhancement of the hot workability of the Cu—Fe—P alloy. If the content of the group A element is less than 0.0001 mass %, the desired effect cannot be obtained. On the other hand, if the content of the group A element exceeds 0.5 mass %, a coarse dispersoid or oxide is produced to deteriorate the bendability of the Cu—Fe—P alloy, and the electrical conductivity significantly decreases as well. Accordingly, the content of the group A element is set to the range of 0.0001 to 0.5 mass %. The lower limit of the content of the group A element is preferably 0.003 mass %, more preferably 0.005 mass %, and the upper limit is preferably 0.4 mass %, more preferably 0.3 mass %.

The group B element (Zr, Ag, Cr, Cd, Be, Ti, Si, Co, Ni, Al, Au, and Pt) has an effect of enhancing the strength of the Cu—Fe—P alloy. If the content of the group B element is less than 0.001 mass % in total, the desired effect cannot be obtained. On the other hand, if the content of the group B element exceeds 0.5 mass % in total, a coarse dispersoid or oxide is produced to deteriorate the bendability of the Cu—Fe—P alloy, and the electrical conductivity significantly decreases as well. Accordingly, the content of the group B element is set to the range of 0.001 to 0.5 mass %. The lower limit of the content of the group B element is preferably 0.003 mass %, more preferably 0.005 mass %, and the upper limit is preferably 0.3 mass %, more preferably 0.2 mass %. Here, in the case where the Cu—Fe—P alloy contains both the group A element and the group B element, the total content thereof is set to be 0.5 mass % or less so as to suppress reduction in the electrical conductivity.

Here, the composition of the above-described Cu—Fe—P alloy is known per se.

### (2) Properties of Cu—Fe—P Alloy

In the Cu—Fe—P alloy sheet material according to this embodiment, it is preferred that in both of the specimens sampled therefrom in the directions parallel (L.D.) and perpendicular (T.D.) to the rolling direction, the 0.2% yield strength is 400 MPa or more and the electrical conductivity is 55% IACS or more. Furthermore, in the direction parallel (L.D.) to the rolling direction, the stress relaxation rate after holding of 150° C.×1,000 hours in the state of being loaded with a bending stress of 80% of 0.2% yield strength is preferably 60% or less. Here, the value of the stress relaxation rate is presumed virtually unchanged between before and after reflow processing.

### (3) Production Method of Cu—Fe—P Alloy

The Cu—Fe—P copper alloy strip is usually produced by subjecting an ingot to scalping, hot rolling, post-hot-rolling rapid cooling or solution treatment, subsequent cold rolling, precipitation annealing, and then finishing cold rolling. The cold rolling and the precipitation annealing are repeated as necessary, and low-temperature annealing is performed as necessary after the finishing cold rolling. This production process itself need not be greatly changed also in the case of the Cu—Fe—P alloy strip (plating matrix) according to this embodiment. In order to enhance the resistance to stress relaxation and the electrical conductivity, conditions for precipitating a large amount of fine precipitates of Fe and Fe—P compound in the Cu alloy strip in the thermo-mechanical treatment step after hot rolling are selected.

The hot rolling is finished at a temperature of 700° C. or more, and water-cooling is immediately performed. In the case of performing a solution treatment after hot rolling, re-heating to a temperature of 700° C. or more is performed, followed by water-cooling from the temperature.

The precipitation annealing is a heat treatment for precipitating fine Fe and Fe—P compound, and the strip is held for 0.5 to 30 hours after its temperature reaches approximately from 300 to 600° C.

In order to improve the resistance to stress relaxation of the Cu—Fe—P copper alloy strip, low-temperature annealing is preferably performed after final cold rolling. In the case of batch annealing, the strip is held for approximately from 10 minutes to 5 hours after its temperature reaches approximately from 300 to 400° C. In the case of continuous annealing, the strip may run continuously through a furnace in an atmosphere of 400 to 650° C. (as the actual temperature condition, the strip is held for approximately from 5 seconds to 1 minute after its temperature reaches approximately from 300 to 400° C.).

On the Cu—Fe—P copper alloy matrix above, the same Cu—Sn copper alloy covering layer and Sn layer as in embodiment A are formed, and the same undercoat layer or Cu covering layer as in embodiment A is further formed, if desired. The production method of the conductive material for connecting parts is also the same as in embodiment A.

### Embodiment C

The embodiment corresponding to claim 5 of the present invention is described below.

### [Copper Alloy Matrix]

### (1) Composition of Cu—Zn Alloy

The Cu—Zn alloy strip according to this embodiment contains from 10 to 40 mass % of Zn, with a remainder being Cu and an unavoidable impurity. This Cu—Zn alloy is called red brass or brass and includes C2200, C2300, C2400, C2600, C2700, and C2801 specified in JIS H 3100.

If the Zn content is less than 10 mass %, the strength required as a mating terminal is insufficient. On the other hand, if the Zn content exceeds 40 mass %, the bendability deteriorates due to reduction in elongation. Accordingly, the Zn content is set to be from 10 to 40 mass %. The lower limit of the Zn content is preferably 12 mass %, more preferably 15 mass %, and the upper limit is preferably 38 mass %, more preferably 35 mass %.

In order to enhance the strength, resistance to stress relaxation and softening resistance of the Cu—Zn alloy, the Cu—Zn alloy may contain from 0.005 to 1 mass % in total of one element or two or more elements selected from Cr, Ti, Zr, Mg, Sn, Ni, Fe, Co, Mn, Al, and P. Of the elements above, Cr, Ti, Zr, Mg, Sn, and Al are effective particularly in enhancing the resistance to stress relaxation. Ni, Fe, Co, and Mn are effective particularly in enhancing the strength and softening resistance when contained together with P to precipitate a phosphide. If the total content of these elements is less than 0.005 mass %, the above-described effects are not obtained, and if it exceeds 1 mass %, the amount of decrease in the electrical conductivity increases. Accordingly, the total content of these elements is set to be from 0.005 to 1 mass %. The lower limit of the total content of the elements is preferably 0.01 mass %, more preferably 0.02 mass %, and the upper limit is preferably 0.7 mass %, more preferably 0.5 mass %. In the case of incorporating P together with one member or two or more members of Ni, Fe, Co, and Mn, the content (mass %) thereof is preferably from 1/20 to ½ of the total content of Ni, Fe, Co, and Mn.

The composition of the Cu—Zn alloy described above is known per se.

### (2) Properties of Cu—Zn Alloy

In the Cu—Zn alloy sheet material according to this embodiment, it is preferred that a specimen sampled therefrom in the direction parallel to the rolling direction satisfies the 0.2% yield strength of 400 MPa or more, the elongation of 5% or more, the electrical conductivity of 24% IACS or more, and the W-shape bendability of R/t≤0.5. The W-shape bendability is measured by the W-shape bending test specified in The Japan Copper and Brass Association Standard JBMA-T307, in which R is the bending radius and t is the sheet thickness. In addition, the stress relaxation rate after holding at 150° C. for 1,000 hours is 75% or less.

### (3) Production Method of Cu—Zn Alloy

The Cu—Zn alloy (plating matrix) according to this embodiment is produced by subjecting a Cu—Zn alloy ingot having the above-described composition to homogenization treatment at 700 to 900° C., hot rolling, removal of oxide scale on the rolled surface of the hot-rolled material, and then a combination of cold rolling and annealing. The reduction of the cold rolling and the heat treatment conditions are determined based on the target strength, average gain size, bendability, etc. In the case of precipitating Cr, Zr, Fe—P, Ni—P, etc., holding is performed at 350 to 600° C. for approximately from 1 to 10 hours. In the case of not precipitating the element above or a phosphide, the heat treatment can be performed in a short time by using a continuous annealing furnace. The Cu—Zn alloy is often used in a rolling-finished state for ensuring the strength, but in order to improve the bendability, remove the internal strain and improve the resistance to stress relaxation, strain-removing annealing (not accompanied by recrystallization) is preferably performed after cold rolling. By adjusting the average grain size to a range of 5 to 15 the bendability when worked into a terminal and the stress relaxation rate of 75% or less after holding at 150° C. for 1,000 hours can be satisfied.

On the Cu—Fe—P copper alloy matrix above, the same Cu—Sn copper alloy covering layer and Sn layer as in embodiment A are formed, and the same undercoat layer or Cu covering layer as in embodiment A is further formed, if desired. The production method of the conductive material for connecting parts is also the same as in embodiment A.

### EXAMPLES

### Test A

### Example 1A

A copper alloy ingot having the composition shown in Table 1 was held for 2 hours after reaching 950° C., hot-rolled and quenched in water from 750° C. or more. Thereafter, by performing cold rolling, solution treatment, cold rolling, and aging treatment, Copper Alloy Sheets A to D of 0.25 mm in thickness, having the mechanical property and electrical conductivity shown in Table 1, were manufactured. These sheet materials were subjected to a surface roughening treatment by a mechanical method (rolling with a roughened roll in the second rolling, or polishing after aging treatment) (Nos. 1A to 11A) or not subjected to a surface roughening treatment (Nos. 12A to 14A) to be finished as copper alloy matrixes having various surface roughnesses. These Copper Alloy Matrixes A to D were subjected to Ni plating (not performed on Nos. 6A, 7A and 14A), then to Cu plating and Sn plating with various thicknesses, and further to reflow processing under various conditions (temperature×time) shown in Table 2 by adjusting the ambient temperature of the reflow processing furnace, to obtain test materials.

The temperature rise rate to the reflow processing temperature was 15° C./sec or more in Nos. 1A to 10A and about 10° C./sec in Nos. 11A to 14A.

Here, H, O, S, and C analyzed in all ingots shown in Table 1 were H: 1 ppm or less, O: from 10 to 20 ppm, S: from 3 to 15 ppm, and C: from 8 to 12 ppm, and ([O]+[S]+[C])×[H]² was 38 or less.

The mechanical property and electrical conductivity of Copper Alloy Sheets A to D were measured in the following manner on a test material sampled from the sheet material before plating.

The 0.2% yield strength was measured based on JIS Z 2241 by using ASTME08 specimens (in the directions parallel (L.D.) and perpendicular (T.D.) to the rolling direction) sampled from each copper alloy sheet.

The stress relaxation rate was measured by a cantilever method. Strip specimens of 10 mm in width and 90 mm in length, the longitudinal direction thereof being the parallel direction (L.D.) or the perpendicular direction (T.D.) relative to the rolling direction of the sheet material, were sampled and fixed to a rigid-body test board at one end thereof. Deflection d (=10 mm) was imposed on the specimen in the position at distance I from the fixed end, and a surface stress corresponding to 80% of 0.2% yield strength of the material in each direction (L.D. or T.D.) was loaded to the fixed end. The distance I was calculated in accordance with “Standard method for stress relaxation test by bending for thin sheets and strips of copper and copper alloys” of The Japan Copper and Brass Association Technical Standard (JCBA-T309:2004). The specimen having imposed thereon deflection was held in an oven heated at 200° C. for 1,000 hours and then taken out. The permanent strain δ after removing the deflection amount d (=10 mm) was measured, and the stress relaxation rate RS=(δ/d)×100 was calculated.

The electrical conductivity was measured at 20° C. in accordance with the method specified in JIS H 0505 by using a specimen (width: 15 mm, length: 300 mm) sampled from each copper alloy sheet in the direction parallel to rolling. Here, the mechanical property, electrical conductivity and stress relaxation rate measured on test materials subjected to plating and reflow processing under the conditions of Table 2 were substantially the same as the results in Table 1.

TABLE 1
Composition and Properties of Cu—Cr Alloy

| | | | | | | | | | | Properties | | | | |
|---|---|---|---|---|---|---|---|---|---|---|---|---|---|---|
| | | | | | | | | | | 0.2% Yield | | | Stress | |
| | | | | | | | | | | Strength | | Electrical | Relaxation | |
| Alloy | Composition of Alloy (mass %) | | | | | | | | | (MPa) | | Conductivity | Rate* | |
| Code | Cu | Cr | Ti | Zr | Si | Ag | Fe | Zn, Sn, Mg | Others | LD | TD | (% IACS) | LD | TD |
| A | remainder | — | — | 0.14 | — | 0.005 | 0.008 | Zn: 0.1 | — | 392 | 395 | 93 | 13 | 12 |
| B | remainder | 0.28 | 0.06 | — | 0.03 | — | — | Zn: 0.02, Sn: 0.01 | Ni: 0.01 | 586 | 572 | 80 | 18 | 17 |
| C | remainder | 0.31 | — | 0.11 | 0.04 | — | 0.01 | Mg: 0.015 | — | 570 | 589 | 81 | 22 | 20 |
| D | remainder | 0.44 | 0.26 | 0.15 | 0.12 | — | 0.04 | Sn: 0.02, Zn: 0.3, | Al: 0.003 | 656 | 641 | 66 | 19 | 17 |
| | | | | | | | | Mg: 0.008 | | | | | | |

*Stress relaxation rate after holding of 200° C. × 1,000 hours

TABLE 2

| | | | | | Cu—Sn Alloy Covering Layer | | | | | Surface | | |
|---|---|---|---|---|---|---|---|---|---|---|---|---|
| | | | | | | | | Surface | | Roughness | | |
| | | Average Thickness of | | | Cu | Surface | Thickness of | Exposure | Average | Ra of | Reflow | Depth of |
| | Alloy | Covering Layer (μm) | | | Content | Exposed | Exposed | Interval | Grain | Covering | Conditions | Fretting |
| No. | Code | Ni | Cu—Sn | Sn | (at %) | Ratio (%) | Region (μm) | (mm) | Size (μm) | Layer (μm) | ° C. × sec | Wear (μm) |
| 1A | B | 0.4 | 0.4 | 0.45 | 45 | 42 | 0.40 | 0.23 | 0.55 | 0.45 | 450 × 15 | 0.6 |
| 2A | B | 0.35 | 0.55 | 0.35 | 50 | 48 | 0.50 | 0.20 | 0.50 | 0.78 | 450 × 20 | 0.5 |
| 3A | B | 0.4 | 0.3 | 0.65 | 56 | 24 | 0.26 | 0.32 | 0.75 | 0.32 | 500 × 10 | 0.7 |
| 4A | B | 0.3 | 0.75 | 1.25 | 54 | 32 | 0.71 | 0.14 | 1.15 | 0.22 | 400 × 30 | 0.8 |
| 5A | B | 1.1 | 0.6 | 0.4 | 48 | 45 | 0.56 | 0.13 | 0.40 | 0.67 | 550 × 10 | 0.4 |
| 6A | B | — | 0.45 | 0.5 | 58 | 36 | 0.40 | 0.15 | 0.90 | 0.30 | 400 × 20 | 0.6 |
| 7A | B | — | 0.25 | 0.55 | 48 | 18 | 0.21 | 0.25 | 0.25 | 0.18 | 500 × 15 | 0.4 |
| 8A | A | 0.4 | 0.4 | 0.4 | 40 | 33 | 0.36 | 0.15 | 0.40 | 0.16 | 450 × 15 | 0.6 |
| 9A | C | 0.3 | 0.5 | 0.35 | 40 | 40 | 0.45 | 0.12 | 0.35 | 0.30 | 500 × 10 | 0.5 |
| 10A | D | 0.45 | 1.45 | 0.55 | 55 | 27 | 1.33 | 0.30 | 0.55 | 0.28 | 450 × 20 | 0.4 |
| 11A | B | 0.4 | 0.35 | 0.65 | 56 | 20 | 0.32 | 0.30 | 3.2* | 0.35 | 280 × 8 | 1.1 |
| 12A | B | 0.4 | 0.4 | 0.55 | 48 | 0* | — | — | 2.6* | 0.07* | 280 × 8 | 1.9 |
| 13A | B | 0.3 | 0.55 | 1.3 | 46 | 0* | — | — | 5.2* | 0.04* | 280 × 8 | 2.5 |
| 14A | B | — | 0.45 | 0.3 | 40 | 0* | — | — | 4.3* | 0.05* | 280 × 8 | 1.7 |

*Item not satisfying the requirement specified in the present invention.

With respect to the test materials obtained, the average thickness of each covering layer, the Cu content of the Cu—Sn alloy covering layer, the exposed area ratio of the Cu—Sn alloy covering layer on the surface of the conductive material, the thickness of the Cu—Sn alloy covering layer exposed at the material surface, the average material surface exposure interval of the Cu—Sn alloy covering layer, the average grain size in the Cu—Sn alloy covering layer surface, and the material surface roughness were measured in the following manner. The results are shown in Table 2. Here, in the test materials of Nos. 1A to 14A, the Cu plating layer disappeared by the reflow processing, and a Cu covering layer was not present.

The measuring methods followed the methods described in Patent Document 2 except the method for measuring the average grain size in the Cu—Sn alloy covering layer surface.

### (Method for Measuring Average Thickness of Ni Covering Layer)

The average thickness of the Ni covering layer after reflow processing was measured by using a fluorescent X-ray thickness gauge (Seiko Instruments Inc.; SFT3200). As for the measurement conditions, a 2-layer calibration curve of Sn/Ni/matrix was used for the calibration curve, and the collimator diameter was set to ϕ0.5 mm. The measurement was performed in three different places of the same test material, and the average value thereof was defined as the average thickness of the Ni covering layer.

### (Method for Measuring Cu Content in Cu—Sn Alloy Covering Layer)

The test material was first immersed in an aqueous solution containing p-nitrophenol and sodium hydroxide as components for 10 minutes to remove the Sn layer. Thereafter, the Cu content in the Cu—Sn alloy covering layer was determined by quantitative analysis using EDX (energy dispersive X-ray spectrometer). The measurement was performed in three different places of the same test material, and the average value thereof was defined as the Cu content in the Cu—Sn alloy covering layer.

### (Method for Measuring Average Thickness of Cu—Sn Alloy Covering Layer)

The test material was first immersed in an aqueous solution containing p-nitrophenol and sodium hydroxide as components for 10 minutes to remove the Sn layer. Thereafter, the film thickness of the Sn component contained in the Cu—Sn alloy covering layer was measured by using a fluorescent X-ray thickness gauge (Seiko Instruments Inc.; SFT3200). As for the measurement conditions, a single-layer calibration curve of Sn/matrix or a 2-layer calibration curve of Sn/Ni/matrix was used for the calibration curve, and the collimator diameter was set to ϕ0.5 mm. The measurement was performed in three different places of the same test material, and the average value thereof was calculated and defined as the average thickness of the Cu—Sn alloy covering layer.

(Method for Measuring Average Thickness of Sn Covering Layer) In the test material, the sum of the film thickness of the Sn covering layer and the film thickness of the Sn component contained in the Cu—Sn alloy covering layer was first measured by using a fluorescent X-ray thickness gauge (Seiko Instruments Inc.; SFT3200). Thereafter, immersion in an aqueous solution containing p-nitrophenol and sodium hydroxide as components was performed for 10 minutes to remove the Sn covering layer. The film thickness of the Sn component contained in the Cu—Sn alloy covering layer was again measured by using the fluorescent X-ray thickness gauge. As for the measurement conditions, a single-layer calibration curve of Sri/matrix or a 2-layer calibration curve of Sn/Ni/matrix was used for the calibration curve, and the collimator diameter was set to ϕ0.5 mm. The average thickness of the Sn covering layer was calculated by subtracting the obtained film thickness of the Sn component contained in the Cu—Sn alloy covering layer from the obtained sum of the film thickness of the Sn covering layer and the film thickness of the Sn component contained in the Cu—Sn alloy covering layer. The measurement was performed in three different places of the same test material, and the average value thereof was defined as the average thickness of the Sn covering layer.

### (Method for Measuring Arithmetic Mean Surface Roughness)

Measurement was performed in accordance with JIS B0601-1994 by using a contact-type profilometer (Tokyo Seimitsu Co., Ltd.; SURFCOM 1400). The surface roughness measurement conditions were set such that the cutoff value was 0.8 mm, the reference length was 0.8 mm, the evaluation length was 4.0 mm, the measuring speed was 0.3 mm/s, and the radius of the probe tip was 5 μmR. The direction of measurement of the surface roughness was set to a direction perpendicular to the direction of rolling or polishing performed in the surface roughening treatment (a direction in which the surface roughness is the largest). The measurement was performed in three different places of the same test material, and the average value thereof was defined as the arithmetic mean roughness.

### (Method for Measuring Exposed Area Ratio of Cu—Sn Alloy Covering Layer on Surface of Conductive Material)

The surface of the test material was observed at a magnification of 200 times by using SEM (scanning electron microscope) having mounted thereon EDX (energy dispersive X-ray spectrometer). The exposed area ratio of the Cu—Sn alloy covering layer on the surface of the material was measured by image analysis from the light and shade (excluding contrast such as stain and scratch) of the obtained composition image. The measurement was performed in three different places of the same test material, and the average value thereof was defined as the exposed area ratio of the Cu—Sn alloy covering layer on the surface of the material.

### (Method for Measuring Average Material Surface Exposure Interval of Cu—Sn Alloy Covering Layer)

The surface of the test material was observed at a magnification of 200 times by using SEM (scanning electron microscope) having mounted thereon EDX (energy dispersive X-ray spectrometer). From the composition image obtained, an average of values obtained by adding the average width of the Cu—Sn alloy covering layer traversing a straight line drawn on the material surface (the length along the straight line) to the average width of the Sn covering layer was determined to thereby measure the average material surface exposure interval of the Cu—Sn alloy covering layer. The direction of measurement (the direction in which the straight line was drawn) was set to a direction perpendicular to the direction of rolling or polishing performed in the surface roughening treatment. The measurement was performed in three different places of the same test material, and the average value thereof was defined as the average material surface exposure interval of the Cu—Sn alloy covering layer.

### (Method for Measuring Thickness of Cu—Sn Alloy Covering Layer Exposed to Material Surface)

A cross section of the test material processed by a microtome method was observed at a magnification of 10,000 times from three different visual fields by using SEM (scanning electron microscope) and with respect to the exposed region of the Cu—Sn alloy covering layer, the minimum value of the thickness was measured in each visual field. Out of three measured values, the smallest value was defined as the thickness of the Cu—Sn alloy covering layer exposed at the material surface.

### (Method for Measuring Average Grain Size in Cu—Sn Alloy Covering Layer Surface)

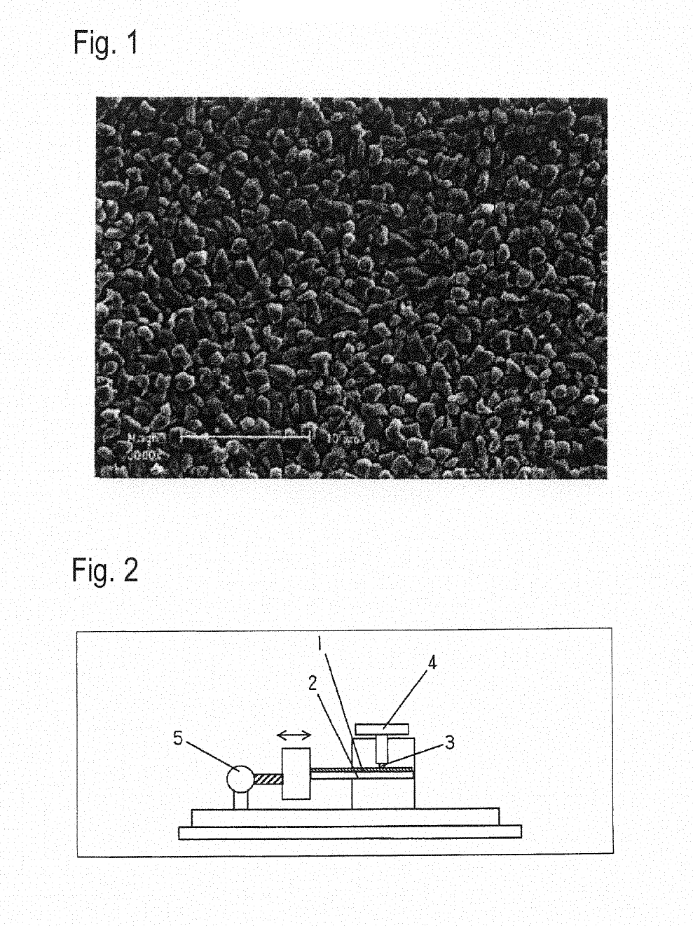

The test material was immersed in an aqueous solution containing p-nitrophenol and sodium hydroxide as components for 10 minutes to remove the Sn covering layer. The surface of the test material was then observed at a magnification of 3,000 times through SEM. The average value of diameters (equivalent-circle diameters) was determined by the image analysis, assuming each grain is a circle, and taken as the average grain size in the Cu—Sn alloy covering layer surface in the observed region. The average grain sizes in three different places of the same test material were determined, and the average value of three values was defined as the average grain size in the Cu—Sn alloy covering layer surface. FIG. 1 shows a surface microstructure photograph of the test material No. 6A.

In addition, a fretting wear test was performed on the obtained test materials in the following manner, and the depth of wear after fretting was measured. The results are also shown in Table 2.

### (Fretting Wear Test)

Simulating the shape of indentation of an electrical contact point in mating-type connecting parts, evaluation was performed by means of a sliding test machine (Yamasaki-Seiki Co., Ltd.; CRS-B1050CHO) illustrated in FIG. 2. First, a male specimen 1 that is a sheet material cut out from each test material was fixed on a horizontal table 2, and a female specimen 3 was put thereon, that is a material cut out from each test material and formed in a hemisphere (having a hemispherical projecting part with an outer diameter of 1.8 mm formed), by arranging the covering layers to be in contact with each other. Here, the same test material was used for the male specimen 1 and the female specimen 3. A load of 3.0 N (weight 4) was applied to the female specimen 3 to push the male specimen 1, and the male specimen 1 was slid in a horizontal direction (by setting the sliding distance to 50 μm and the sliding frequency to 1 Hz) by using a stepping motor 5. The arrow is the sliding direction. Both the male specimen 1 and the female specimen 3 had been sampled such that the longitudinal direction thereof and the rolling direction intersect at right angles.

The male specimen 1 having been subjected to fretting of 100 times of slidings was processed by a microtome method, and a cross section of the wear track was observed at a magnification of 10,000 times by SEM (scanning electron microscope). The maximum depth of wear track observed was taken as the depth of wear after fretting. Three pieces were cut out from the same test material for each of the male specimen 1 and the female specimen 3, and the test was performed three times. The maximum value of three measurement results was defined as the depth of wear after fretting of the test material.

As shown in Table 2, Nos. 1A to 10A satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. In No. 11A where the reflow processing temperature was low and the temperature rise rate was small, the average grain size in the Cu—Sn alloy covering layer surface is 3.2 μm and does not satisfy the requirement specified in the present invention. On the other hand, in Nos. 1A to 10A where the reflow processing temperature was high and the temperature rise rate was large, the average grain size in the Cu—Sn alloy covering layer surface satisfies the requirement specified in the present invention. In all of Nos. 1 A to 10A, the depth of fretting wear is smaller than in No. 11A, and among others, when No. 3A and No. 11A, using the same material for the matrix and having a similar covering layer structure, are compared, the depth of fretting wear of No. 3A is reduced to 64% of the depth of wear of No. 7A.

Here, in No. 11A as well, the depth of wear after fretting is small compared with Nos. 12A to 14A in which the exposed area ratio of the Cu—Sn alloy covering layer on the surface of the conductive material is zero (the Cu—Sn alloy covering layer is not exposed at the outermost surface).

### Example 2A

Copper alloy ingots of Alloy Code B shown in Table 1 were, by the similar method as in Example 1A, subjected to a surface roughening treatment by a mechanical method (rolling or polishing) (Nos. 15A to 22A) or not subjected to a surface roughening treatment (Nos. 23A to 25A) to be finished as copper alloy matrixes (0.2% yield strength: LD: from 576 to 593 MPa, TD: from 564 to 580 MPa, electrical conductivity: from 79 to 81% IACS, stress relaxation rate: LD: from 17 to 18%, TD: from 16 to 17%) having various surface roughnesses. The copper alloy matrixes were subjected to undercoat plating (with one member or two members of Ni, Co and Fe) (not performed on Nos. 21A and 25A), then to Cu plating and Sn plating with various thicknesses, and further to reflow processing under various conditions (temperature×time) shown in Table 3 by adjusting the ambient temperature of the reflow processing furnace, to obtain test materials. The temperature rise rate to the reflow processing temperature was 15° C./sec or more in Nos. 15A to 21A and about 10° C./sec in Nos. 22A to 25A.

TABLE 3

| | | | | | Cu—Sn Alloy Covering Layer | | | | | Surface | | | |
|---|---|---|---|---|---|---|---|---|---|---|---|---|---|
| | | Average Thickness of | | | | Surface | Thickness | Surface | Average | Roughness | | | |
| | | Covering Layer (μm) | | | Cu | Exposed | of Exposed | Exposure | Grain | Ra of | Reflow | Depth of | |
| | Alloy | Under- | | | Content | Ratio | Region | Interval | Size | Covering | Conditions | Fretting | Friction |
| No. | Code | coat** | Cu—Sn | Sn | (at %) | (%) | (μm) | (mm) | (μm) | Layer (μm) | ° C. × sec | Wear (μm) | Coefficient |
| 15A | B | Ni: 0.5 | 0.45 | 0.4 | 55 | 44 | 0.39 | 0.12 | 0.4 | 0.33 | 500 × 15 | 0.6 | 0.27 |
| 16A | B | Ni: 0.4 | 0.4 | 0.07 | 58 | 65 | 0.35 | 0.05 | 0.5 | 0.45 | 450 × 20 | 0.3 | 0.19 |
| 17A | B | Fe: 0.4 | 0.6 | 1.0 | 60 | 13 | 0.56 | 0.23 | 1.7 | 0.19 | 400 × 20 | 0.9 | 0.39 |
| 18A | B | Co: 0.5 | 0.5 | 0.4 | 55 | 48 | 0.43 | 0.16 | 0.6 | 0.50 | 500 × 15 | 0.4 | 0.25 |
| 19A | B | Ni: 0.4 | 0.4 | 0.55 | 55 | 33 | 0.34 | 0.20 | 0.3 | 0.47 | 600 × 8 | 0.5 | 0.30 |
| | | Co: 0.5 | | | | | | | | | | | |
| 20A | B | Ni: 0.3 | 0.8 | 1.6 | 54 | 11 | 0.72 | 0.24 | 0.85 | 0.21 | 550 × 15 | 1.1 | 0.42 |
| | | Fe: 0.4 | | | | | | | | | | | |
| 21A | B | — | 0.45 | 0.13 | 63 | 53 | 0.40 | 0.07 | 0.45 | 0.56 | 500 × 15 | 0.7 | 0.20 |
| 22A | B | Ni: 0.4 | 0.4 | 0.8 | 55 | 24 | 0.35 | 0.23 | 2.6* | 0.36 | 280 × 10 | 2.0 | 0.38 |
| 23A | B | Ni: 0.4 | 0.4 | 0.4 | 53 | 0* | — | — | 2.5* | 0.07* | 280 × 8 | 2.8 | 0.50 |
| 24A | B | Ni: 0.5 | 0.7 | 1.5 | 55 | 0* | — | — | 3.6* | 0.04* | 280 × 10 | 3.6 | 0.71 |
| 25A | B | — | 0.5 | 0.9 | 57 | 0* | — | — | 2.9* | 0.07* | 280 × 10 | 1.7 | 0.55 |

*Item not satisfying the requirement specified in the present invention
**In the case where the undercoat layer is composed of 2 layers, the upper layer is in contact with the Cu—Sn alloy layer, and the lower layer is in contact with the matrix.

With respect to the test materials obtained, the same measurements and tests as in Example 1 were performed. In addition, with respect to the test materials obtained, measurement of the average thickness of each of the Co covering layer and the Fe covering layer and measurement of the friction coefficient were performed in the following manner. The results are shown in Table 3. Here, in the test materials of Nos. 11 to 25, the Cu plating layer had disappeared.

### (Measurement of Average Thickness of Co Layer)

The average thickness of the Co layer of the test material was measured by using a fluorescent X-ray thickness gauge (Seiko Instruments Inc.; SFT3200). As for the measurement conditions, a 2-layer calibration curve of Sn/Co/matrix was used for the calibration curve, and the collimator diameter was set to ϕ0.5 mm. The measurement was performed in three different places of the same test material, and the average value thereof was defined as the average thickness of the Co covering layer.

### (Measurement of Average Thickness of Fe Layer)

The average thickness of the Fe layer of the test material was measured by using a fluorescent X-ray thickness gauge (Seiko Instruments Inc.; SFT3200). As for the measurement conditions, a 2-layer calibration curve of Sn/Fe/matrix was used for the calibration curve, and the collimator diameter was set to ϕ0.5 mm. The measurement was performed in three different places of the same test material, and the average value thereof was defined as the average thickness of the Fe covering layer.

### (Measurement of Friction Coefficient)

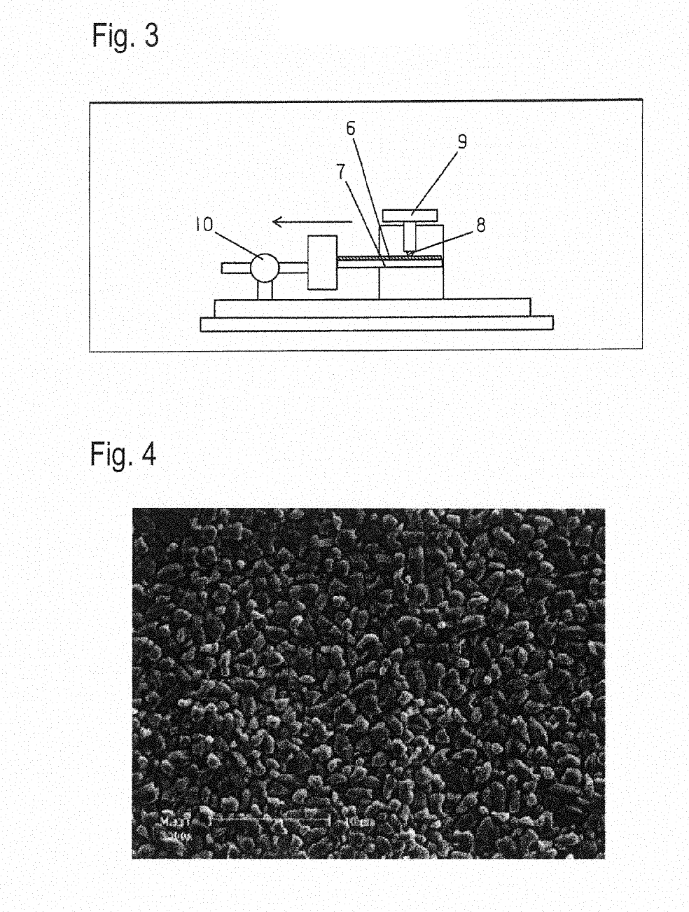

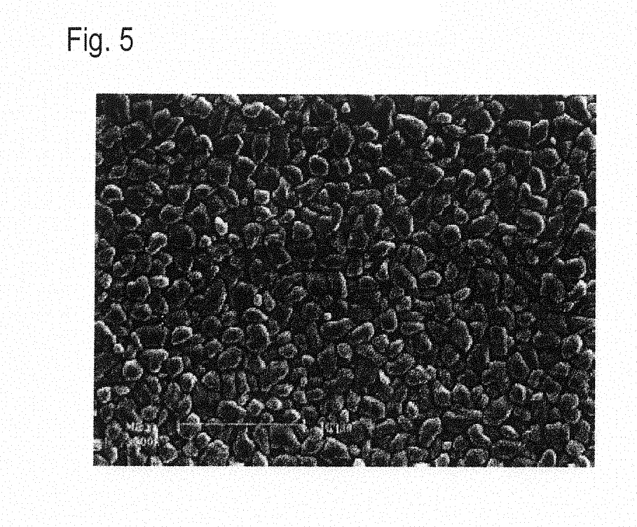

Simulating the shape of indentation of an electrical contact point in mating-type connecting parts, measurement was performed by means of a device as illustrated in FIG. 3. First, a male specimen 6 that is a sheet material cut out from each test material of Nos. 15A to 25A was fixed on a horizontal table 7, and a female specimen 8 was put thereon, that is a material cut out from the test material of No. 23A (the Cu—Sn alloy layer was not exposed at the surface) and formed in a hemisphere (the outer diameter was set to ϕ1.8 mm), by arranging the surfaces to be in contact with each other. Subsequently, a load of 3.0 N (weight 9) was applied to the female specimen 8 to push the male specimen 6, and the male specimen 6 was pulled in the horizontal direction (the sliding speed was set to 80 mm/min) by using a horizontal load measuring device (Aikoh Engineering Co., Ltd.; Model-2152) to measure the maximum frictional force F (unit: N) until a sliding distance of 5 mm. The friction coefficient was determined according to the following formula (1). Here, 10 is a load cell, the arrow is the sliding direction, and the sliding direction is set to a direction perpendicular to the rolling direction. Both the male specimen 1 and the female specimen 3 were prepared such that the longitudinal direction thereof and the rolling direction intersect at right angles.

Friction coefficient=F/3.0 (1)

Three pieces were cut out from the same test material for each of the male specimen 1 and the female specimen 3, and the test was performed three times. The maximum value of three measurement results was defined as the friction coefficient of the test material.

As shown in Table 3, Nos. 15A to 21 satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. In No. 22A where the reflow processing temperature was low and the temperature rise rate was small, the average grain size in the Cu—Sn alloy covering layer surface is 2.6 μm and does not satisfy the requirement specified in the present invention. On the other hand, in Nos. 15A to 21A where the reflow processing temperature was high and the temperature rise rate was large, the average grain size in the Cu—Sn alloy covering layer surface satisfies the requirement specified in the present invention. In all of Nos. 15A to 21A, the depth of fretting wear is smaller than in No. 22A. Here, in No. 22A as well, the depth of wear after fretting is small compared with Nos. 23A to 25A in which the exposed area ratio of the Cu—Sn alloy covering layer on the surface of the conductive material is zero (the Cu—Sn alloy covering layer is not exposed at the outermost surface).

In addition, in Nos. 16A and 21A where the average thickness of the Sn covering layer was less than 0.2 μm, the friction coefficient is extremely low.

### Example 3A

No. 15A manufactured in Example 2A, which is an Example of the Invention, was subjected after reflow processing to bright Sn electroplating with various thicknesses to obtain test materials of Nos. 26A to 29A. The average thickness of the Sn plating layer was measured in the following manner, and the results are shown in Table 4. With respect to the obtained test materials, a solder wettability evaluation test was performed, in addition to the same fretting wear test and friction coefficient measurement test as in Example 2A. The results are shown in Table 4.

TABLE 4

| | | Average | | | | | | |
|---|---|---|---|---|---|---|---|---|
| | | Thickness | | | Thickness of Sn | | | |
| | | of Covering | | | Plating Layer on | Depth of | | |
| | Alloy | Layer (μm) | | | Outermost | Fretting | Friction | Solder |
| No. | Code | Ni | Cu—Sn | Sn | Surface (μm) | Wear (μm) | Coefficient | Wettability |
| 15A | B | 0.5 | 0.45 | 0.4 | 0 | 0.7 | 0.27 | C |
| 26A | | | | | 0.02 | 0.7 | 0.28 | B |
| 27A | | | | | 0.1 | 0.8 | 0.31 | A |
| 28A | | | | | 0.2 | 0.9 | 0.37 | A |
| 29A | | | | | 0.3* | 1.1 | 0.44 | A |

*Item not satisfying the requirement specified in the present invention.

### (Method for Measuring Average Thickness of Sn Plating Layer)

With respect to the test materials of Nos. 26A to 29A, the average thickness of the entire Sn covering layer (including the Sn plating layer formed by bright Sn electroplating) was determined by the measuring method described in Example 1A. The average thickness of the Sn plating layer was calculated by subtracting the average thickness of the Sn covering layer (not including the Sn plating layer formed by bright Sn electroplating) of No. 15A from the average thickness of the entire Sn covering layer.

### (Solder Wettability Test)

A specimen cut out from each of the test materials Nos. 15A and 26A to 29A was immersed in and coated with an inactive flux for 1 second, and then the zero cross time and the maximum wetting stress were measured by the meniscograph method. The solder composition was Sn-3.0 Ag-0.5 Cu, and the specimen was immersed in the solder at 255° C. The immersion conditions were set to an immersion rate of 25 mm/sec, an immersion depth of 12 mm, and an immersion time of 5.0 sec. The solder wettability has standards of zero cross time ≤2.0 sec and maximum wetting stress ≥5 mN, and a specimen satisfying both standards was rated as A, a specimen satisfying either one standard was rated as B, and a specimen satisfying neither standards was rated as C.

As shown in Table 4, Nos. 26A to 29A have a Sn plating layer on the outermost surface and therefore, have good solder wettability compared with No. 15A. Among others, in Nos. 26A to 28A where the average thickness of the Sn plating layer on the outermost surface satisfies the requirement specified in the present invention, both low friction coefficient and solder wettability were provided and the depth of fretting wear was small. In No. 29A, the solder wettability was good, but the friction coefficient was large.

### Test B

### Example 1B

A copper alloy ingot having the composition shown in Table 5 was held for 2 hours after reaching 900 to 950° C., hot-rolled and quenched in water from 750° C. or more. Thereafter, by performing cold rolling, annealing and cold rolling, Copper Alloy Sheets A to D of 0.25 mm in thickness, having the mechanical property and electrical conductivity shown in Table 5, were manufactured. These sheet materials were subjected to a surface roughening treatment by a mechanical method (rolling with a roughened roll in the second rolling, or polishing after second cold rolling) (Nos. 1B to 11B) or not subjected to a surface roughening treatment (Nos. 12B to 14B) to be finished as copper alloy matrixes having various surface roughnesses. These Cu—Fe—P Alloy Matrixes A to D were subjected to Ni plating (not performed on Nos. 6B, 7B and 14B), then to Cu plating and Sn plating with various thicknesses, and further to reflow processing under various conditions (temperature×time) shown in Table 6 by adjusting the ambient temperature of the reflow processing furnace, to obtain test materials.

The temperature rise rate to the reflow processing temperature was 15° C./sec or more in Nos. 1B to 10B and about 10° C./sec in Nos. 11B to 14B.

Here, the mechanical property and electrical conductivity of the Cu—Fe—P alloy sheet were measured in the same manner as in Example 1A on a test material sampled from the sheet material before plating. However, as for the stress relaxation rate, the heating temperature of the specimen was set to 150° C.

TABLE 5
Composition and Properties of Cu—Fe—P Alloy

| | | | | | | | | Properties | | | | |
|---|---|---|---|---|---|---|---|---|---|---|---|---|
| | | | | | | | | | | | Stress | |
| | Alloy Composition (mass %) | | | | | | | 0.2% Yield | | Electrical | Relaxation | |
| Alloy | | | | | | Group A | | Strength (MPa) | | Conductivity | Rate* | |
| Code | Cu | Fe | P | Sn | Zn | Element | Group B Element | LD | TD | (% IACS) | LD | TD |
| A | remainder | 0.11 | 0.034 | — | — | — | — | 423 | 436 | 91 | 51 | 58 |
| B | remainder | 0.3 | 0.088 | 0.02 | 0.35 | — | — | 540 | 546 | 79 | 32 | 44 |
| C | remainder | 2.16 | 0.028 | 0.07 | 0.18 | Mg: 0.01, | Cr: 0.01, Al: 0.01 | 461 | 458 | 68 | 31 | 42 |
| | | | | | | Mn: 0.015 | Co: 0.045 | | | | | |
| D | remainder | 1.7 | 0.045 | 0.15 | 0.25 | Mg: 0.15 | Si: 0.008 | 602 | 586 | 58 | 28 | 32 |

*Stress relaxation rate after holding of 150° C. × 1,000 hours

TABLE 6

| | | | | | Cu—Sn Alloy Covering Layer | | | | | Surface | | |
|---|---|---|---|---|---|---|---|---|---|---|---|---|
| | | | | | | | | Surface | | Roughness | | |
| | | Average Thickness of | | | Cu | Surface | Thickness of | Exposure | Average | Ra of | Reflow | Depth of |
| | Alloy | Covering Layer (μm) | | | Content | Exposed | Exposed | Interval | Grain Size | Covering | Conditions | Fretting |
| No. | Code | Ni | Cu—Sn | Sn | (at %) | Ratio (%) | Region (μm) | (mm) | (μm) | Layer (μm) | ° C. × sec | Wear (μm) |
| 1B | B | 0.4 | 0.45 | 0.5 | 45 | 40 | 0.40 | 0.24 | 0.58 | 0.47 | 450 × 20 | 0.6 |
| 2B | B | 0.35 | 0.6 | 0.35 | 48 | 52 | 0.52 | 0.19 | 0.55 | 0.81 | 450 × 25 | 0.5 |
| 3B | B | 0.4 | 0.3 | 0.6 | 55 | 24 | 0.27 | 0.26 | 0.60 | 0.31 | 525 × 10 | 0.6 |
| 4B | B | 0.3 | 0.75 | 1.2 | 53 | 34 | 0.70 | 0.13 | 0.95 | 0.23 | 400 × 30 | 0.7 |
| 5B | B | 1.1 | 0.65 | 0.4 | 47 | 47 | 0.58 | 0.16 | 0.35 | 0.70 | 575 × 8 | 0.4 |
| 6B | B | — | 0.45 | 0.25 | 59 | 38 | 0.40 | 0.24 | 0.77 | 0.30 | 400 × 20 | 0.5 |
| 7B | B | — | 0.3 | 0.55 | 48 | 15 | 0.21 | 0.20 | 0.23 | 0.17 | 500 × 15 | 0.5 |
| 8B | A | 0.4 | 0.4 | 0.4 | 42 | 32 | 0.36 | 0.15 | 0.40 | 0.16 | 450 × 15 | 0.6 |
| 9B | C | 0.3 | 0.45 | 0.35 | 40 | 40 | 0.42 | 0.11 | 0.36 | 0.32 | 500 × 10 | 0.4 |
| 10B | D | 0.5 | 1.4 | 0.55 | 55 | 26 | 1.34 | 0.30 | 0.56 | 0.27 | 450 × 20 | 0.4 |
| 11B | B | 0.4 | 0.35 | 0.65 | 57 | 24 | 0.30 | 0.31 | 3.5* | 0.34 | 280 × 10 | 1.6 |
| 12B | B | 0.4 | 0.4 | 0.55 | 48 | 0* | — | — | 2.4* | 0.07* | 280 × 10 | 1.9 |
| 13B | B | 0.3 | 0.55 | 1.2 | 46 | 0* | — | — | 5.5* | 0.04* | 280 × 10 | 2.7 |
| 14B | B | — | 0.45 | 0.4 | 40 | 0* | — | — | 4.1* | 0.05* | 280 × 10 | 1.7 |

*Item not satisfying the requirement specified in the present invention

With respect to the test materials obtained, the average thickness of each covering layer, the Cu content of the Cu—Sn alloy covering layer, the exposed area ratio of the Cu—Sn alloy covering layer on the surface of the conductive material, the thickness of the Cu—Sn alloy covering layer exposed at the material surface, the average material surface exposure interval of the Cu—Sn alloy covering layer, the average grain size in the Cu—Sn alloy covering layer surface, and the material surface roughness were measured in the following manner. The results are shown in Table 6. Here, in the test materials of Nos. 1B to 14B, the Cu plating layer disappeared by the reflow processing, and a Cu covering layer was not present.

The measuring methods followed the methods described in Patent Document 2 except the method for measuring the average grain size in the Cu—Sn alloy covering layer surface.

As the method for measuring the average thickness of the Ni covering layer, the method for measuring the average thickness of the Cu—Sn alloy covering layer, the method for measuring the average thickness of the Sn covering layer, the method for measuring the surface roughness, the method for measuring the exposed area ratio of the Cu—Sn alloy covering layer on the surface of the conductive material, the method for measuring the average material surface exposure interval of the Cu—Sn alloy covering layer, the method for measuring the thickness of the Cu—Sn alloy covering layer exposed at the material surface, and the method for measuring the average grain size in the Cu—Sn alloy covering layer surface, measurements were performed by the same methods as in Example 1A. FIG. 4 shows a surface microstructure photograph of the test material No. 4B.

In addition, a fretting wear test was performed on the obtained test materials by the same method as in Example 1A, and the depth of wear after fretting was measured. The results are also shown in Table 6.

As shown in Table 6, Nos. 1B to 10B satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. In No. 11B where the reflow processing temperature was low and the temperature rise rate was small, the average grain size in the Cu—Sn alloy covering layer surface is 3.5 μm and does not satisfy the requirement specified in the present invention. On the other hand, in Nos. 1B to 10B where the reflow processing temperature was high and the temperature rise rate was large, the average grain size in the Cu—Sn alloy covering layer surface satisfies the requirement specified in the present invention.

In all of Nos. 1B to 10B, the depth of fretting wear is smaller than in No. 11B, and among others, when No. 3B and No. 11B, using the same material for the matrix and having a similar covering layer structure, are compared, the depth of fretting wear of No. 3B is reduced to 38% of the depth of wear of No. 11B.

Here, in No. 11B as well, the depth of fretting wear is small compared with Nos. 12B to 14B in which the exposed area ratio of the Cu—Sn alloy covering layer on the surface of the conductive material is zero (the Cu—Sn alloy covering layer is not exposed at the outermost surface).

### Example 2B

Cu—Fe—P alloy ingots of Alloy Code B shown in Table 5 were, by the similar method as in Example 1B, subjected to a surface roughening treatment by a mechanical method (rolling or polishing) (Nos. 15B to 22B) or not subjected to a surface roughening treatment (Nos. 23B to 25B) to be finished as copper alloy matrixes (0.2% yield strength: LD: from 533 to 544 MPa, TD: from 539 to 551 MPa, electrical conductivity: from 78 to 82% IACS, stress relaxation rate: LD: from 31 to 32%, TD: from 43 to 14%) having various surface roughnesses. The copper alloy matrixes were subjected to undercoat plating (with one member or two members of Ni, Co and Fe) (not performed on Nos. 21B and 25B), then to Cu plating and Sn plating with various thicknesses, and further to reflow processing under various conditions (temperature×time) shown in Table 7 by adjusting the ambient temperature of the reflow processing furnace, to obtain test materials. The temperature rise rate to the reflow processing temperature was 15° C./sec or more in Nos. 15B to 21B and about 10° C./sec in Nos. 22B to 25B.

TABLE 7

| | | | | | Cu—Sn Alloy Covering Layer | | | | | Surface | | | |
|---|---|---|---|---|---|---|---|---|---|---|---|---|---|
| | | Average Thickness of | | | | Surface | | Surface | Average | Roughness | | | |
| | | Covering Layer (μm) | | | Cu | Exposed | Thickness of | Exposure | Grain | Ra of | Reflow | Depth of | |
| | Alloy | Under- | | | Content | Ratio | Exposed | Interval | Size | Covering | Conditions | Fretting | Friction |
| No. | Code | coat** | Cu—Sn | Sn | (at %) | (%) | Region (μm) | (mm) | (μm) | Layer (μm) | ° C. × sec | Wear (μm) | Coefficient |
| 15B | B | Ni: 0.5 | 0.45 | 0.45 | 56 | 44 | 0.38 | 0.11 | 0.4 | 0.32 | 500 × 15 | 0.7 | 0.25 |
| 16B | B | Ni: 0.4 | 0.4 | 0.07 | 59 | 66 | 0.37 | 0.05 | 0.5 | 0.46 | 450 × 20 | 0.4 | 0.20 |
| 17B | B | Fe: 0.5 | 0.6 | 1.0 | 58 | 13 | 0.56 | 0.23 | 1.8 | 0.20 | 400 × 20 | 0.9 | 0.40 |
| 18B | B | Co: 0.5 | 0.5 | 0.4 | 56 | 50 | 0.46 | 0.16 | 0.7 | 0.53 | 500 × 15 | 0.5 | 0.25 |
| 19B | B | Ni: 0.4 | 0.35 | 0.6 | 55 | 34 | 0.32 | 0.19 | 0.3 | 0.45 | 600 × 8 | 0.6 | 0.30 |
| | | Co: 0.4 | | | | | | | | | | | |
| 20B | B | Ni: 0.4 | 0.8 | 1.7 | 55 | 12 | 0.74 | 0.25 | 0.9 | 0.19 | 550 × 10 | 1.2 | 0.41 |
| | | Fe: 0.4 | | | | | | | | | | | |
| 21B | B | — | 0.45 | 0.13 | 64 | 55 | 0.41 | 0.07 | 0.45 | 0.53 | 500 × 15 | 0.7 | 0.21 |
| 22B | B | Ni: 0.4 | 0.4 | 0.8 | 55 | 24 | 0.35 | 0.22 | 2.7* | 0.37 | 280 × 10 | 2.0 | 0.39 |
| 23B | B | Ni: 0.4 | 0.4 | 0.4 | 53 | 0* | — | — | 2.5* | 0.07* | 280 × 8 | 2.7 | 0.50 |
| 24B | B | Ni: 0.5 | 0.7 | 1.5 | 55 | 0* | — | — | 3.7* | 0.04* | 280 × 10 | 3.5 | 0.70 |
| 25B | B | — | 0.5 | 0.9 | 57 | 0* | — | — | 2.9* | 0.07* | 280 × 10 | 3.0 | 0.56 |

*Item not satisfying the requirement specified in the present invention
**In the case where the undercoat layer is composed of 2 layers, the upper layer is in contact with the Cu—Sn alloy layer, and the lower layer is in contact with the matrix.

With respect to the test materials obtained, the same measurements and tests as in Example 1B were performed. In addition, with respect to the test materials obtained, measurement of the average thickness of each of the Co covering layer and the Fe covering layer and measurement of the friction coefficient were performed by the same methods as in Example 2A. The results are shown in Table 7. Here, in the test materials of Nos. 15B to 25B, the Cu plating layer had disappeared.

As shown in Table 7, Nos. 15B to 21B satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. In No. 22B where the reflow processing temperature was low and the temperature rise rate was small, the average grain size in the Cu—Sn alloy covering layer surface is 2.7 μm and does not satisfy the requirement specified in the present invention. On the other hand, in Nos. 15B to 21B where the reflow processing temperature was high and the temperature rise rate was large, the average grain size in the Cu—Sn alloy covering layer surface satisfies the requirement specified in the present invention. In all of Nos. 15B to 21B, the depth of fretting wear is smaller than in No. 22B. Here, in No. 22B as well, the depth of wear after fretting is small compared with Nos. 23B to 25B in which the exposed area ratio of the Cu—Sn alloy covering layer on the surface of the conductive material is zero (the Cu—Sn alloy covering layer is not exposed at the outermost surface).

In addition, in Nos. 16B and 21B where the average thickness of the Sn covering layer was less than 0.2 μm, the friction coefficient is extremely low.

### Example 3B

No. 15B manufactured in Example 2B, which is an Example of the Invention, was subjected after reflow processing to bright Sn electroplating with various thicknesses to obtain test materials of Nos. 26B to 29B. The average thickness of the Sn plating layer was measured in the following manner, and the results are shown in Table 8. With respect to the obtained test materials, a solder wettability evaluation test was performed, in addition to the same fretting wear test and friction coefficient measurement test as in Example 2B. The results are shown in Table 8.

TABLE 8

| | | Average Thickness | | | Thickness of Sn | | | |
|---|---|---|---|---|---|---|---|---|
| | | of Covering | | | Plating Layer on | Depth of | | |
| | Alloy | Layer (μm) | | | Outermost | Fretting | Friction | Solder |
| No. | Code | Ni | Cu—Sn | Sn | Surface (μm) | Wear (μm) | Coefficient | Wettability |
| 15B | B | 0.5 | 0.45 | 0.45 | 0 | 0.7 | 0.25 | C |
| 26B | | | | | 0.02 | 0.7 | 0.27 | B |
| 27B | | | | | 0.1 | 0.8 | 0.30 | A |
| 28B | | | | | 0.2 | 0.9 | 0.36 | A |
| 29B | | | | | 0.3* | 1.1 | 0.44 | A |

*Item not satisfying the requirement specified in the present invention

### (Method for Measuring Average Thickness of Sn Plating Layer)

With respect to the test materials of Nos. 26B to 29B, the average thickness of the entire Sn covering layer (including the Sn plating layer formed by bright Sn electroplating) was determined by the measuring method described in Example 1B. The average thickness of the Sn plating layer was calculated by subtracting the average thickness of the Sn covering layer (not including the Sn plating layer formed by bright Sn electroplating) of No. 15B from the average thickness of the entire Sn covering layer.

### (Solder Wettability Test)

A specimen cut out from each of the test materials Nos. 15B and 26B to 29B was immersed in and coated with an inactive flux for 1 second, and then the zero cross time and the maximum wetting stress were measured by the meniscograph method. The solder composition was Sn-3.0 Ag-0.5 Cu, and the specimen was immersed in the solder at 255° C. The immersion conditions were set to an immersion rate of 25 mm/sec, an immersion depth of 12 mm, and an immersion time of 5.0 sec. The solder wettability has standards of zero cross time ≤2.0 sec and maximum wetting stress ≥5 mN, and a specimen satisfying both standards was rated as A, a specimen satisfying either one standard was rated as B, and a specimen satisfying neither standards was rated as C.

As shown in Table 8, Nos. 26B to 29B have a Sn plating layer on the outermost surface and therefore, have good solder wettability compared with No. 15B. Among others, in Nos. 26B to 28B where the average thickness of the Sn plating layer on the outermost surface satisfies the requirement specified in the present invention, both low friction coefficient and solder wettability were provided and the depth of fretting wear was small. In No. 29B, the solder wettability was good, but the friction coefficient was large.

### Test C

### Example 1C

A copper alloy ingot having the composition shown in Table 9 was held for 2 hours after reaching 700 to 850° C. and hot-rolled, and quenched in water after the hot rolling was completed. Thereafter, by performing cold rolling, annealing, cold rolling, and stress relief annealing (under conditions not allowing recrystallization to occur), Copper Alloy Sheets A to D of 0.25 mm in thickness, having the mechanical property and electrical conductivity shown in Table 9, were manufactured. These sheet materials were subjected to a surface roughening treatment by a mechanical method (rolling with a roughened roll in the second rolling, or polishing after second cold rolling) (Nos. 1C to 11C) or not subjected to a surface roughening treatment (Nos. 12C to 14C) to be finished as copper alloy matrixes having various surface roughnesses. These Cu—Zn Alloy

Matrixes A to D were subjected to Ni plating (not performed on Nos. 6C, 7C and 14C), then to Cu plating and Sn plating with various thicknesses, and further to reflow processing under various conditions (temperature×time) shown in Table 10 by adjusting the ambient temperature of the reflow processing furnace, to obtain test materials. The temperature rise rate to the reflow processing temperature was 15° C./sec or more in Nos. 1C to 10C and about 10° C./sec in Nos. 11C to 14C.

The mechanical property, stress relaxation rate and electrical conductivity were measured in the same manner as in Example 1 A on a test material sampled from the sheet material before plating. However, the 0.2% yield strength and elongation were measured on a tensile specimen sampled such that the longitudinal direction thereof becomes a direction (LD) parallel to the rolling direction, and the stress relaxation rate was measured by using a specimen sampled such that the longitudinal direction thereof runs in parallel to the LD direction, and setting the heating temperature of the specimen to 150° C. Here, the average grain size and the W bendability of the Cu—Zn alloy sheet were measured in the following manner.

The average grain size was measured in a cross section perpendicular to the surface of the Cu—Zn alloy sheet and parallel to the rolling direction by a cutting method (cutting direction is in the sheet thickness direction) based on JIS H 0501.

The W bendability was measured by the W bending test method specified in The Japan Copper and Brass Association Standard JBMA-T307. The specimen was prepared such that the longitudinal direction thereof runs in parallel to the rolling direction, and GW (good way) bending was performed.

TABLE 9
Composition and Properties of Cu—Zn Alloy

| | | | | Properties | | | | | |
|---|---|---|---|---|---|---|---|---|---|
| | Alloy Composition (mass %) | | | 0.2% Yield | | Electrical | Average | | |
| Alloy | | | Other | Strength | | Conductivity | Grain Size | W Bending | Stress Relaxation |
| No. | Cu | Zn | Elements | (MPa) | Elongation (%) | (% IACS) | (μm) | R/t | Rate (%) |
| A | remainder | 11.6 | — | 415 | 12 | 43 | 10 | 0.5 | 67 |
| B | remainder | 30.8 | — | 496 | 18 | 28 | 7 | 0.5 | 72 |
| C | remainder | 28.7 | Zr: 0.05 | 504 | 17 | 27 | 5 | 0.5 | 61 |
| | | | Sn: 0.18 | | | | | | |
| D | remainder | 39.6 | — | 510 | 13 | 27 | 5 | 0.5 | 75 |

TABLE 10

| | | | | | Cu—Sn Alloy Covering Layer | | | | | Surface | | |
|---|---|---|---|---|---|---|---|---|---|---|---|---|
| | | | | | | Surface | | Surface | | Roughness | | |
| | | Average Thickness of | | | Cu | Exposed | Thickness of | Exposure | Average | Ra of | Reflow | Depth of |
| | Alloy | Covering Layer (μm) | | | Content | Ratio | Exposed | Interval | Grain Size | Covering | Conditions | Fretting |
| No. | Code | Ni | Cu—Sn | Sn | (at %) | (%) | Region (μm) | (mm) | (μm) | Layer (μm) | ° C. × sec | Wear (μm) |
| 1C | B | 0.3 | 0.45 | 0.5 | 40 | 38 | 0.40 | 0.25 | 0.60 | 0.48 | 450 × 20 | 0.7 |
| 2C | B | 0.35 | 0.6 | 0.3 | 45 | 57 | 0.53 | 0.18 | 0.60 | 0.84 | 450 × 25 | 0.4 |
| 3C | B | 0.4 | 0.3 | 0.65 | 56 | 23 | 0.28 | 0.23 | 0.40 | 0.30 | 550 × 10 | 0.7 |
| 4C | B | 0.3 | 0.75 | 1.3 | 52 | 36 | 0.70 | 0.14 | 0.50 | 0.21 | 400 × 30 | 0.6 |
| 5C | B | 1.2 | 0.65 | 0.35 | 46 | 49 | 0.61 | 0.13 | 0.30 | 0.74 | 600 × 8 | 0.4 |
| 6C | B | — | 0.45 | 0.25 | 60 | 42 | 0.41 | 0.16 | 0.80 | 0.30 | 400 × 20 | 0.5 |
| 7C | B | — | 0.25 | 0.6 | 48 | 13 | 0.21 | 0.23 | 0.20 | 0.18 | 500 × 15 | 1.0 |
| 8C | A | 0.4 | 0.4 | 0.4 | 40 | 33 | 0.36 | 0.15 | 0.40 | 0.16 | 450 × 20 | 0.6 |
| 9C | C | 0.3 | 0.5 | 0.35 | 40 | 40 | 0.46 | 0.12 | 0.35 | 0.33 | 500 × 10 | 0.4 |
| 10C | D | 0.5 | 1.5 | 0.6 | 54 | 27 | 1.36 | 0.31 | 1.31 | 0.26 | 450 × 30 | 0.9 |
| 11C | B | 0.4 | 0.35 | 0.65 | 57 | 20 | 0.32 | 0.30 | 3.20* | 0.33 | 280 × 10 | 1.5 |
| 12C | B | 0.4 | 0.4 | 0.55 | 47 | 0* | — | — | 2.60* | 0.07* | 280 × 10 | 1.9 |
| 13C | B | 0.3 | 0.55 | 1.25 | 45 | 0* | — | — | 5.20* | 0.04* | 280 × 10 | 2.8 |
| 14C | B | — | 0.45 | 0.35 | 40 | 0* | — | — | 4.30* | 0.05* | 280 × 10 | 1.6 |

*Item not satisfying the requirement specified in the present invention

With respect to the test materials obtained, the average thickness of each covering layer, the Cu content of the Cu—Sn alloy covering layer, the exposed area ratio of the Cu—Sn alloy covering layer on the surface of the conductive material, the thickness of the Cu—Sn alloy covering layer exposed at the material surface, the average material surface exposure interval of the Cu—Sn alloy covering layer, the average grain size in the Cu—Sn alloy covering layer surface, and the material surface roughness were measured in the following manner. The results are shown in Table 10. Here, in the test materials of Nos. 1C to 14C, the Cu plating layer disappeared by the reflow processing, and a Cu covering layer was not present.

The measuring methods followed the methods described in Patent Document 2 except the method for measuring the average grain size in the Cu—Sn alloy covering layer surface.

As the method for measuring the average thickness of the Ni covering layer, the method for measuring the average thickness of the Cu—Sn alloy covering layer, the method for measuring the average thickness of the Sn covering layer, the method for measuring the surface roughness, the method for measuring the exposed area ratio of the Cu—Sn alloy covering layer on the surface of the conductive material, the method for measuring the average material surface exposure interval of the Cu—Sn alloy covering layer, the method for measuring the thickness of the Cu—Sn alloy covering layer exposed at the material surface, and the method for measuring the average grain size in the Cu—Sn alloy covering layer surface, measurements were performed by the same methods as in Example 1A. FIG. 4 shows a surface microstructure photograph of the test material No. 4B.

As shown in Table 10, Nos. 1C to 11C satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. Of these, in No. 11C where the reflow processing temperature was low and the temperature rise rate was small, the average grain size in the Cu—Sn alloy covering layer surface is 3.20 μm and does not satisfy the requirement specified in the present invention. On the other hand, in Nos. 1C to 10C where the reflow processing temperature was high and the temperature rise rate was large, the average grain size in the Cu—Sn alloy covering layer surface satisfies the requirement specified in the present invention. In all of Nos. 1C to 10C, the depth of fretting wear is smaller than in No. 11C, and among others, when No. 3C and No. 11C, using the same material for the matrix and having a similar covering layer structure, are compared, the depth of fretting wear of No. 3C is reduced to 47% of the depth of wear of No. 7C.

Here, in No. 11C as well, the depth of fretting wear is small compared with Nos. 12C to 14C in which the exposed area ratio of the Cu—Sn alloy covering layer on the surface of the conductive material is zero (the Cu—Sn alloy covering layer is not exposed at the outermost surface).

### Example 2C

Cu—Zn alloy ingots of Alloy Code B in Table 9 were, by the similar method as in Example 1C, subjected to a surface roughening treatment by a mechanical method (rolling or polishing) (Nos. 15C to 22C) or not subjected to a surface roughening treatment (Nos. 23C to 25C) to be finished as copper alloy matrixes (0.2% yield strength: from 486 to 502 MPa, elongation: from 17 to 19%, electrical conductivity: 28% IACS, stress relaxation rate: from 68 to 73%) having various surface roughnesses. The copper alloy matrixes were subjected to undercoat plating (with one member or two members of Ni, Co and Fe) (not performed on Nos. 21C and 25C), then to Cu plating and Sn plating with various thicknesses, and further to reflow processing under various conditions (temperature×time) shown in Table 11 by adjusting the ambient temperature of the reflow processing furnace, to obtain test materials. The temperature rise rate to the reflow processing temperature was 15° C./sec or more in Nos. 15C to 21C and about 10° C./sec in Nos. 22C to 25C.

TABLE 11

| | | | | | Cu—Sn Alloy Covering Layer | | | | | | | | |
|---|---|---|---|---|---|---|---|---|---|---|---|---|---|
| | | | | | | | Thickness | | | Surface | | | |
| | | Average Thickness of | | | | | of | Surface | | Roughness | | | |
| | | Covering Layer (μm) | | | Cu | Surface | Exposed | Exposure | Average | Ra of | Reflow | Depth of | |
| | Alloy | Under- | | | Content | Exposed | Region | Interval | Grain Size | Covering | Conditions | Fretting | Friction |
| No. | Code | coat** | Cu—Sn | Sn | (at %) | Ratio (%) | (μm) | (mm) | (μm) | Layer (μm) | ° C. × sec | Wear (μm) | Coefficient |
| 15C | B | Ni: 0.4 | 0.4 | 0.45 | 57 | 43 | 0.37 | 0.11 | 0.4 | 0.31 | 500 × 15 | 0.7 | 0.28 |
| 16C | B | Ni: 0.4 | 0.4 | 0.07 | 60 | 67 | 0.38 | 0.06 | 0.5 | 0.47 | 450 × 20 | 0.3 | 0.17 |
| 17C | B | Fe: 0.4 | 0.6 | 1.0 | 55 | 13 | 0.55 | 0.23 | 1.7 | 0.21 | 400 × 20 | 0.9 | 0.39 |
| 18C | B | Co: 0.5 | 0.5 | 0.4 | 56 | 52 | 0.48 | 0.15 | 0.7 | 0.55 | 500 × 15 | 0.4 | 0.25 |
| 19C | B | Ni: 0.5 | 0.3 | 0.6 | 55 | 36 | 0.29 | 0.18 | 0.3 | 0.43 | 600 × 10 | 0.5 | 0.31 |
| | | Co: 0.4 | | | | | | | | | | | |
| 20C | B | Ni: 0.3 | 0.8 | 1.7 | 55 | 11 | 0.76 | 0.26 | 0.95 | 0.18 | 550 × 15 | 1.1 | 0.42 |
| | | Fe: 0.3 | | | | | | | | | | | |
| 21C | B | — | 0.4 | 0.11 | 64 | 56 | 0.37 | 0.07 | 0.45 | 0.51 | 500 × 15 | 0.7 | 0.22 |
| 22C | B | Ni: 0.3 | 0.4 | 0.8 | 55 | 25 | 0.38 | 0.21 | 2.7* | 0.38 | 280 × 10 | 1.3 | 0.37 |
| 23C | B | Ni: 0.4 | 0.4 | 0.4 | 53 | 0* | — | — | 2.5* | 0.07* | 280 × 10 | 2.6 | 0.48 |
| 24C | B | Ni: 0.5 | 0.7 | 1.5 | 55 | 0* | — | — | 3.8* | 0.04* | 280 × 10 | 3.3 | 0.65 |
| 25C | B | — | 0.5 | 0.8 | 56 | 0* | — | — | 2.9* | 0.08* | 280 × 10 | 1.9 | 0.57 |

*Item not satisfying the requirement specified in the present invention
**In the case where the undercoat layer is composed of 2 layers, the upper layer is in contact with the Cu—Sn alloy layer, and the lower layer is in contact with the matrix.

With respect to the test materials obtained, the same measurements and tests as in Example 1C were performed. In addition, with respect to the test materials obtained, measurement of the average thickness of each of the Co covering layer and the Fe covering layer and measurement of the friction coefficient were performed by the same methods as in Example 2A. The results are shown in Table 11. Here, in the test materials of Nos. 15C to 25C, the Cu plating layer had disappeared.

As shown in Table 11, Nos. 15C to 22C satisfy the requirements specified in the present invention as to the average thickness of each covering layer, the Cu content of the Cu—Sn alloy covering layer, the material surface roughness, the exposed area ratio of the Cu—Sn alloy covering layer on the surface of the conductive material, the thickness of the Cu—Sn alloy covering layer exposed at the material surface, and the average material surface exposure interval of the Cu—Sn alloy covering layer. Of these, in No. 22C where the reflow processing temperature was low and the temperature rise rate was small, the average grain size in the Cu—Sn alloy covering layer surface is 2.7 μm and does not satisfy the requirement specified in the present invention. On the other hand, in Nos. 15C to 21C where the reflow processing temperature was high and the temperature rise rate was large, the average grain size in the Cu—Sn alloy covering layer surface satisfies the requirement specified in the present invention.

In all of Nos. 15C to 21C, the depth of fretting wear is smaller than in No. 22C. Here, in No. 22C as well, the depth of wear after fretting is small compared with Nos. 23C to 25C in which the exposed area ratio of the Cu—Sn alloy covering layer on the surface of the conductive material is zero (the Cu—Sn alloy covering layer is not exposed at the outermost surface).

In addition, in Nos. 16C and 21C where the average thickness of the Sn covering layer was less than 0.2 μm, the friction coefficient is extremely low.

### Example 3C

No. 15C manufactured in Example 2C, which is an Example of the Invention, was subjected after reflow processing to bright Sn electroplating with various thicknesses to obtain test materials of Nos. 26C to 29C. The average thickness of the Sn plating layer was measured in the following manner, and the results are shown in Table 12. With respect to the obtained test materials, a solder wettability evaluation test was performed, in addition to the same fretting wear test and friction coefficient measurement test as in Example 2C. The results are shown in Table 12.

TABLE 12

| | | Average Thickness | | | Thickness of Sn | | | |
|---|---|---|---|---|---|---|---|---|
| | | of Covering | | | Plating Layer on | Depth of | | |
| | Alloy | Layer (μm) | | | Outermost | Fretting | Friction | Solder |
| No. | Code | Ni | Cu—Sn | Sn | Surface (μm) | Wear (μm) | Coefficient | Wettability |
| 15C | B | 0.4 | 0.4 | 0.45 | 0 | 0.7 | 0.28 | C |
| 26C | | | | | 0.03 | 0.7 | 0.30 | B |
| 27C | | | | | 0.1 | 0.8 | 0.33 | A |
| 28C | | | | | 0.2 | 0.9 | 0.4 | A |
| 29C | | | | | 0.3* | 1.1 | 0.47 | A |

### (Method for Measuring Average Thickness of Sn Plating Layer)

With respect to the test materials of Nos. 26C to 29C, the average thickness of the entire Sn covering layer (including the Sn plating layer formed by bright Sn electroplating) was determined by the measuring method described in Example 1C. The average thickness of the Sn plating layer was calculated by subtracting the average thickness of the Sn covering layer (not including the Sn plating layer formed by bright Sn electroplating) of No. 15C from the average thickness of the entire Sn covering layer.

### (Solder Wettability Test)

A specimen cut out from each of the test materials Nos. 15C and 26C to 29C was immersed in and coated with an inactive flux for 1 second, and then the zero cross time and the maximum wetting stress were measured by the meniscograph method. The solder composition was Sn-3.0 Ag-0.5 Cu, and the specimen was immersed in the solder at 255° C. The immersion conditions were set to an immersion rate of 25 mm/sec, an immersion depth of 12 mm, and an immersion time of 5.0 sec. The solder wettability has standards of zero cross time ≤2.0 sec and maximum wetting stress ≥5 mN, and a specimen satisfying both standards was rated as A, a specimen satisfying either one standard was rated as B, and a specimen satisfying neither standards was rated as C.

As shown in Table 12, Nos. 26C to 30C have a Sn plating layer on the outermost surface and are therefore improved in the solder wettability compared with No. 15C. Among others, in Nos. 26C to 28C where the average thickness of the Sn plating layer on the outermost surface satisfies the requirement specified in the present invention, both low friction coefficient and solder wettability were provided and the depth of fretting wear was small. On the other hand, in No. 29C, the solder wettability was good, but the friction coefficient was large.

While the present invention has been described in detail and with reference to specific embodiments thereof, it will be apparent to one skilled in the art that various changes and modifications can be made therein without departing from the spirit and scope of the present invention.

The present application is based on a Japanese patent application filed on Aug. 25, 2014 (Application No. 2014-170879), a Japanese patent application filed on Aug. 25, 2014 (Application No. 2014-170956) and a Japanese patent application filed on Aug. 27, 2014 (Application No. 2014-172281), the contents thereof being incorporated herein by reference.

### INDUSTRIAL APPLICABILITY

The conductive material for connecting parts of the present invention can more reduce the fretting wear than ever before and is useful for a terminal, etc. used in the automotive field and the general consumer field.

### DESCRIPTION OF REFERENCE NUMERALS AND SIGNS

1, 6 Male specimen
2, 7 Table
3, 8 Female specimen
4, 9 Weight
5 Stepping motor
10 Load cell

1-2. (canceled)

3. A conductive material, comprising:
(i) a copper alloy strip as a matrix, the copper alloy strip comprising:
Cu,
0.01 to 2.6 mass % of Fe, and
0.01 to 0.3 mass % of P,
(ii) a Cu—Sn alloy covering layer having a Cu content of 20 to 70 at %, and
(iii) a Sn covering layer, formed in this order on a surface of the matrix,
wherein:
a surface of the conductive material has been subjected to a reflow processing and has an arithmetic mean roughness Ra in at least one direction of 0.15 μm or more and an arithmetic mean roughness Ra in all directions of 3.0 μm or less,
the Sn covering layer has an average thickness of from 0.05 to 5.0 μm,
the Cu—Sn alloy covering layer has been formed to be partially exposed at a surface of the Sn covering layer,
the Cu—Sn alloy covering layer has an exposed area ratio of from 3 to 75% on the surface of the conductive material,
the Cu—Sn alloy covering layer has an average thickness of from 0.2 to 3.0 μm and an average grain size in a surface thereof of less than 2 μm, and
the copper alloy strip has an electrical conductivity of more than 55% IACS and a stress relaxation rate after holding at 150° C. for 1,000 hours of 60% or less.

4. The conductive material according to claim 3, wherein the copper alloy strip further comprises at least one member selected from the group consisting of (C) and (D):
(C) at least one member selected from the group consisting of 0.001 to 0.5% of Sn and 0.005 to 3.0% of Zn; and
(D) from 0.001 to 0.5 mass % in total of one or more members selected from the group consisting of Mn, Mg, Ca, Zr, Ag, Cr, Cd, Be, Ti, Si, Co, Ni, Al, Au, and Pt.

5-9. (canceled)

10. The conductive material according to claim 3, further comprising an undercoat layer comprising one layer or two layers selected from the group consisting of a Ni covering layer, a Co covering layer and a Fe covering layer, the undercoat layer having been fainted between the surface of the matrix and the Cu—Sn alloy covering layer, wherein the undercoat layer has an average thickness, singularly in the case of one layer or in total of both layers in the case of two layers, of from 0.1 to 3.0 μm.

11. The conductive material according to claim 3, further comprising a Sn plating layer having an average thickness of 0.02 to 0.2 μm formed on the material surface which has been subjected to the reflow processing.

12. The conductive material according to claim 10, further comprising a Sn plating layer having an average thickness of 0.02 to 0.2 μm formed on the material surface which has been subjected to the reflow processing.

13. The conductive material according to claim 4, further comprising an undercoat layer comprising one layer or two layers selected from the group consisting of a Ni covering layer, a Co covering layer and a Fe covering layer, the undercoat layer having been formed between the surface of the matrix and the Cu—Sn alloy covering layer, wherein the undercoat layer has an average thickness, singularly in the case of one layer or in total of both layers in the case of two layers, of from 0.1 to 3.0 μm.

14. The conductive material according to claim 13, further comprising a Sn plating layer having an average thickness of 0.02 to 0.2 μm formed on the material surface which has been subjected to the reflow processing.
